(19) United States
(12) Patent Application Publication
(10) Pub. No.: US 2026/0239470 A1
(43) Pub. Date: Aug. 13, 2026

(54) FIRST NETWORK NODE, SECOND NETWORK NODE, AND METHODS PERFORMED THEREBY, FOR HANDLING ONE OR MORE CONNECTIONS

(71) Applicant: Telefonaktiebolaget LM Ericsson (publ), Stockholm (SE)

(72) Inventors: Piotr WOCH, Kobylany (PL); Klas STRÖMBERG, Linköping (SE); Peter WERNER, Linköping (SE); Angelo CENTONZA, Granada (ES)

(21) Appl. No.: 19/471,203

(22) PCT Filed: Apr. 2, 2024
(86) PCT No.: PCT/EP2024/058867

§ 371 Date: Sep. 30, 2025

Related U.S. Application Data
(60) Provisional application No. 63/494,245, filed on Apr. 5, 2023.

(51) Int. Cl. H04W 76/19; H04W 74/0833; H04W 88/08

(52) U.S. Cl. CPC H04W 76/19; H04W 74/085; H04W 88/08

(57) ABSTRACT

A method performed by a first network node operating in a communications network. The first network node determines that a re-binding between one or more signalling connections from one or more wireless devices and a Transport Network Layer Association (TNLA) is to be performed. The first network node then sends, to a second network node operating in the communications network, a first message indicating that the re-binding is to be performed. The first message further indicates how the re-binding is to be performed. The first message is a dedicated message. One of the following apply: a) the first message indicates to which TNLA the one or more wireless devices are to be rebound, and b) the first message is sent over the TNLA to which the one or more wireless devices are to be rebound.

### TECHNICAL FIELD

The present disclosure relates generally to a first network node and methods performed thereby for handling one or more connections. The present disclosure further relates generally to a second network node and methods performed thereby, for handling the one or more connections.

### BACKGROUND

A communications network, e.g., a wireless communications network, may cover a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell may be understood to be the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams.

Wireless devices within the wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The standardization organization 3rd Generation Partnership Project (3GPP) is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

In NR, base stations, which may be referred to as gNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The 3GPP RAN interface F1-C between a gNB-Centralized Unit (CU) and gNB-Distributed Unit (DU) may support the use of multiple Transport Network Layer Associations (TNLAs). A Transport Network Layer Association, e.g., an SCTP association, (TNLA) may be understood to be a transport layer connection between two network nodes and their corresponding endpoints. Multiple TNLAs may also be supported by E1, NG and Xn-C interfaces [1].

Information regarding a User Equipment (UE) may be communicated over a single TNLA. This may be called the F1AP UE TNLA binding. The F1-C interface may be understood to carry information of many different sorts, such as about cells, public warning messages and positioning. The UE associated signalling may include, e.g., procedures for UE context management, Radio Resource control (RRC) message transfer and tracing. The F1AP UE TNLA binding may be understood as a binding between an F1AP UE association and a specific TNL association for a given UE. After the F1AP UE TNLA binding may be created, the gNB-CU may update the UE TNLA binding by sending the F1AP message for the UE to the gNB-DU via a different TNLA.” [1].

Similarly, there may be an E1AP UE TNLA binding, an NGAP UE TNLA binding and an XnAP UE TNLA binding. As stated above, in case of F1AP, the CU may have the possibility to switch which TNLA may be used. The specifications also allow for the gNB-DU to change the UE TNLA, Stream Control Transmission Protocol (SCTP) association, under certain circumstances. For a single UE-associated signalling, the gNB-DU may have to use one SCTP association and one SCTP stream, and the SCTP association and/or stream may not be changed during the communication of the UE-associated signalling until after a current SCTP association may have failed, or a TNL binding update may be performed [2].

US Patent Application Publication No. 2022/0030512 A1 [3], describes a method where the CU may set weight factors on the TNLAs to instruct the DU which TNLA to use for new NR stand-alone (SA) UE set ups. The described method may add the possibility of: load balancing UEs over existing TNLAs, off-loading an existing TNLA to a new TNLA, and graceful shutdown of a TNLA to be deleted.

### SUMMARY

As part of the development of embodiments herein, one or more challenges with the existing technology will first be identified and discussed.

Multiple TNLAs may be understood as a function supported in many standardized network interfaces such as F1-C, E1, NG and Xn-C. Such functionality may be supported by the 3GPP specifications, however, the fault handling and fail-over is not detailed.

Examples of the issues that are unresolved so far are as follows.

One unresolved issue may be understood to be that both the nodes involved in multiple TNLA configurations may update the binding between a UE signalling connection and a TNLA in case of a failure, but none of them may be understood to have precedence. This may lead to a synchronization problem, that is, a race condition, where each of the two nodes may request a different binding update. As a result, the procedure of re-binding the UE signalling connection to a new TNLA may be understood to not converge, with a risk of UE disconnections, e.g., UE drop.

Another unresolved issue may be understood to be that it may be possible to add and remove TNLAs, but it is not described what may need to happen to the UEs served by the TNLAs that are removed. 3GPP TS 38.401, rel. 17, v. 17.3.0, chapters 8.8, 8.10 and 11.1 mentions that TNLA re-binding to a new TNLA is possible, but it does not provide solutions that may allow an immediate re-binding of the UEs affected to a new TNLA, nor it provides solutions that resolve the race conditions described above.

Yet another unresolved issue may be understood to be that one of the possible options for re-binding a UE associated signalling connection to a new TNLA may be to signal any upcoming UE associated message over the new TNLA association. However, there is no dedicated procedure for rebinding and no existing UE procedure without side effects. For example, a UE TNLA change may have to wait until there may be a meaningful procedure to initiate, that is, e.g., a UE Context Management, RRC Message Transfer or Trace procedure related to the UE that may have been sent regardless of single or multiple TNLAs being used, which may lead to rebinding delays. If a procedure wants to be “forced”, e.g., sent even if there may be no need for it, just for the sake of carrying out the rebinding, then there may be side effects because the UE-associated procedures available today, e.g., UE Context Management, RRC Message Transfer or Trace, may all be understood to have a purpose, that is, another function than to update the UE TNLA binding, and using one of such procedures for no reason may lead to bad configurations.

US Patent Application Publication No. 2022/0030512 A1 makes selection of TNLA for new UE set ups possible, but has the following limitations. One limitation may be understood to be that the weight factors set by the CU may only affect future UE setups, e.g., existing UEs may not be transferred to another TNLA. Thus, existing UEs may not be retained in case of a failure, e.g., TNLA failure.

Another limitation may be understood to be that it may take a long time to empty a TNLA, as it may require all the UEs to disconnect on their own initiative.

Yet another limitation may be understood to be that it may assume that the DU may select a TNLA by initiating the Initial UL RRC Message Transfer procedure on it, but the standard specifies that this procedure may be required to be sent on the single TNLA employed for non-UE associated signalling. That is, when a new may UE connect to the DU, the first message sent from DU to CU over F1-C may be understood to be the “Initial UL RRC Message Transfer”. This may be required, according to the standard, to be sent on the single TNLA used for non-UE associated signalling, even though it may regard a single UE. If the standard is to be followed, the TNLA may have to be decided by the CU in a later message. Accordingly, weight factors may not need to be transferred to the DU at all, as it may be understood to be the CU that may make the binding decision.

It is therefore an object of embodiments herein to improve the handling of handling one or more connections in a wireless communications network.

According to a first aspect of embodiments herein, the object is achieved by a method, performed by a first network node. The method is for handling one or more connections. The first network node operates in a communications network. The first network node determines that a re-binding between one or more signalling connections from one or more wireless devices and a TNLA is to be performed. The first network node then sends, to a second network node operating in the communications network, a first message. The first message indicates that the re-binding is to be performed. The first message further indicates how the re-binding is to be performed. The first message is a dedicated message. One of the following applies: a) the first message indicates to which TNLA the one or more wireless devices are to be rebound, and b) the first message is sent over the TNLA to which the one or more wireless devices are to be rebound.

According to a second aspect of embodiments herein, the object is achieved by a method, performed by the second network node. The method is for handling the one or more connections. The second network node operates in the communications network. The second network node receives, from the first network node operating in the communications network the first message. The first message indicates that the re-binding between the one or more signalling connections, from the one or more wireless devices and the TNLA is to be performed. The first message further indicates how the re-binding is to be performed. The first message is the dedicated message, and one of the following applies: a) the first message indicates to which TNLA the one or more wireless devices are to be rebound, and b) the first message is received over the TNLA to which the one or more wireless devices are to be rebound.

According to a third aspect of embodiments herein, the object is achieved by the first network node. The first network node may be understood to be for handling the one or more connections. The first network node is configured to operate in the communications network. The first network node is configured to determine that the re-binding between the one or more signalling connections from the one or more wireless devices and the TNLA is to be performed. The first network node is also configured to send, to the second network node configured to operate in the communications network, the first message configured to indicate that the re-binding is to be performed. The first message is configured to further indicate how the re-binding is to be performed. The first message is configured to be a dedicated message, and one of the following applies: a) the first message is configured to indicate to which TNLA the one or more wireless devices are to be rebound, and b) the first message is configured to be sent over the TNLA to which the one or more wireless devices are to be rebound.

According to a fourth aspect of embodiments herein, the object is achieved by the second network node. The network node may be understood to be for handling the one or more connections. The second network node is configured to operate in the communications network. The second network node is further configured to receive, from the first network node configured to operate in the communications network, the first message configured to indicate that the re-binding between the one or more signalling connections from the one or more wireless devices and the TNLA is to be performed. The first message is configured to further indicate how the re-binding is to be performed. The first message is configured to be the dedicated message, and one of: a) the first message is configured to indicate to which TNLA the one or more wireless devices are to be rebound, and b) the first message is configured to be received over the TNLA to which the one or more wireless devices are to be rebound.

By determining that a re-binding between the one or more signalling connections, from the one or more wireless devices and the TNLA is to be performed, the first network node may enable that the one or more wireless devices 130 may instantly be bound to another TNLA. For example, the first network node may enable no longer having to wait until there may be a meaningful procedure to initiate a UE TNLA change, which may lead to rebinding delays. The first network node may enable to avoid having to force a procedure e.g., sent even if there may be no need for it, just for the sake of carrying out the rebinding, and thereby avoid that there may be side effects that may lead to bad configurations.

The first network node may further enable avoiding having to wait for all the UEs to disconnect on their own initiative to empty a TNLA, which may be understood to take a long time.

By sending the first message indicating that the re-binding is to be performed, and how the re-binding is to be performed, in a dedicated message, the first network node may enable an explicit procedure for updating the TNLA bindings of the one or more wireless devices, e.g., the UE TNLA bindings.

By introducing a UE TNLA rebind procedure, a set of the one or more wireless devices, e.g., UEs, may instantly be bound to another TNLA. This may be understood to enable keeping the sessions of the one or more wireless devices, e.g., UE sessions, during, e.g.: failures on interface level, internal errors, and termination of TNLAs. It may also enable load-balancing of the one or more wireless devices, e.g., UEs, and minimize the risk of conflicting rebind decisions between the communicating network nodes.

Yet another advantage may be understood to be that if a TNLA is to be removed, the UEs bound to it may be retained and it may be explicitly specified to which TNLA the UEs may need to be rebound. As an example, for a cloud implementation, this graceful TNLA removal may be applied when the microservice instance terminating the TNLA may need to be upgraded.

A further advantage may be understood to be that with a rebind procedure the semantics may be clearer, rather than having the TNLA UE rebinding as a side-effect of another UE associated procedure.

### BRIEF DESCRIPTION OF THE DRAWINGS

Examples of embodiments herein are described in more detail with reference to the accompanying drawings, according to the following description.

FIG. 1 is a schematic diagram depicting three non-limiting examples of a communications network, according to embodiments herein.

FIG. 2 is a flowchart depicting a method in a first network node, according to embodiments herein.

FIG. 3 is a flowchart depicting a method in a second network node, according to embodiments herein.

FIG. 4 is a schematic diagram illustrating a non-limiting example of aspects of methods disclosed herein, according to some examples.

FIG. 5 is a schematic diagram illustrating a non-limiting example of methods disclosed herein, according to some examples.

FIG. 6 is a schematic diagram illustrating a non-limiting example of methods disclosed herein, according to some examples.

FIG. 7 is a schematic diagram illustrating a non-limiting example of methods disclosed herein, according to some examples.

FIG. 8 is a schematic diagram illustrating a non-limiting example of methods disclosed herein, according to some examples.

FIG. 9 is a schematic diagram illustrating a non-limiting example of aspects of methods disclosed herein, according to some examples.

FIG. 10 is a schematic diagram illustrating a non-limiting example of methods disclosed herein, according to some examples.

FIG. 11 is a schematic diagram illustrating a non-limiting example of aspects of methods disclosed herein, according to some examples.

FIG. 12 is a schematic diagram illustrating a non-limiting example of methods disclosed herein, according to some examples.

FIG. 13 is a schematic diagram illustrating a non-limiting example of methods disclosed herein, according to some examples.

FIG. 14 is a schematic block diagram illustrating an embodiment of a first network node, according to embodiments herein.

FIG. 15 is a schematic block diagram illustrating an embodiment of a second network node, according to embodiments herein.

FIG. 16 is a flowchart depicting a method in a first network node, according to examples related to embodiments herein.

FIG. 17 is a flowchart depicting a method in a second network node, according to examples related to embodiments herein.

FIG. 18 is a schematic block diagram illustrating an example of a communication system 1800 in accordance with some embodiments.

FIG. 19 is a schematic block diagram illustrating an example of a UE 1900 in accordance with some embodiments.

FIG. 20 is a schematic block diagram illustrating an example of a network node 2000 in accordance with some embodiments.

FIG. 21 is a schematic block diagram illustrating a host 2100, which may be an embodiment of the host 1816 of FIG. 18, in accordance with various aspects described herein.

FIG. 22 is a schematic block diagram illustrating an example of a virtualization environment 2200 in which functions implemented by some embodiments may be virtualized.

FIG. 23 shows a communication diagram of a host 2302 communicating via a network node 2304 with a UE 2306 over a partially wireless connection in accordance with some embodiments.

### DETAILED DESCRIPTION

Certain aspects of the present disclosure and their embodiments may provide solutions to the challenges described in the Summary section or other challenges. Embodiments herein may be generally understood relate to a UE TNLA rebind procedure for RAN interfaces. Particularly, embodiments herein may be understood to introduce an explicit procedure for updating the UE TNLA bindings and for the establishment of prioritization between nodes involved in the TNLA binding, in case of conflicting rebinding indications.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

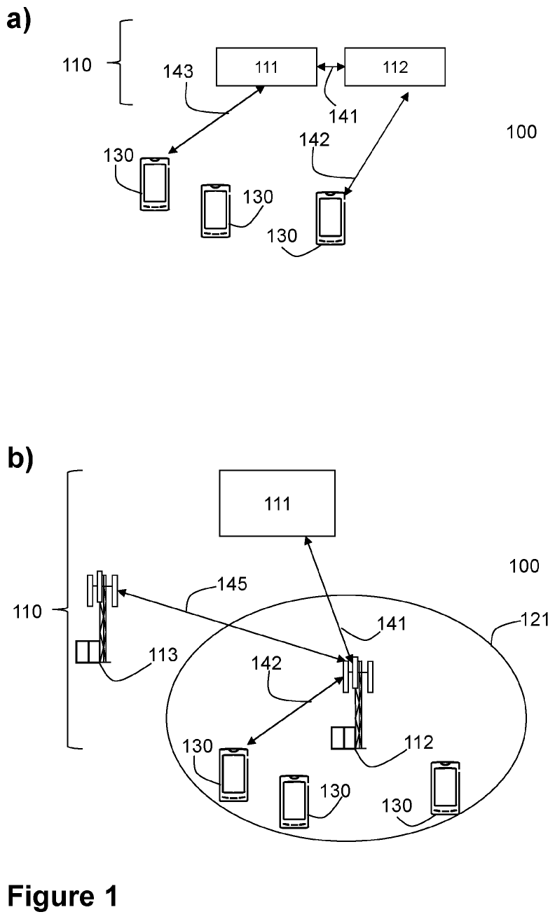

FIG. 1 depicts three non-limiting examples, in panels a), b), c), and d), respectively, of a wireless network or communications network 100, sometimes also referred to as a wireless communications network, wireless communications system, cellular radio system, or cellular network, in which embodiments herein may be implemented. The communications network 100 may be a 5G system, 5G network, or Next Gen System or network. The communications network 100 may support or be a newer system than a 5G system, such as, for example a sixth generation (6G) system. In particular embodiments herein, the communications network 100 may be a Cloud RAN network. In other examples, the communications network 100 may in addition or alternatively, support other technologies such as, for example, Long-Term Evolution (LTE), e.g., LTE-M, LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. Yet in other examples, the communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The communications network 100 may also support Machine Type Communication (MTC), evolved MTC (eMTC), Internet of Things (IoT) and/or NarrowBand IoT (NB-IoT). Thus, although terminology from 5G/NR and LTE may be used in this disclosure to exemplify embodiments herein, this should not be seen as limiting the scope of the embodiments herein to only the aforementioned system. In future telecommunication networks, e.g., in 6G, the terms used herein may need to be reinterpreted in view of possible terminology changes in future technologies.

The communications network 100 may comprise a plurality of network nodes 110, whereof a first network node 111, and a second network node 112 are depicted in the non-limiting examples of panel a), panel b), panel c) and panel d) in FIG. 1. The communications network 100 may further comprise, in some embodiments, a third network node 113, also depicted in panel b) and panel c) of FIG. 1. Any of the plurality of network nodes 110, such as the first network node 111, the second network node 112 and the third network node 113 may be a radio network node, e.g., a transmission point such as a radio base station, for example a gNB, or any other network node with similar features capable of serving a user equipment, such as a wireless device or a machine type communication device, in the communications network 100. In some examples, any of the plurality of network nodes 110, such as the first network node 111, the second network node 112 and the third network node 113 may be a distributed node and may partially perform its functions in collaboration with a virtual node in a cloud 115, or may be a node in the cloud 115, performing all of its functions in the cloud 115, as depicted in panel c) of FIG. 1 for the second network node 112. Any of the plurality of network nodes 110, such as the first network node 111, the second network node 112 and the third network node 113 may be directly connected to one or more core networks, e.g., to one or more network nodes in the one or more core networks. Any of the plurality of network nodes 110, such as the first network node 111, the second network node 112 and the third network node 113 may be also referred to as an access node. It may be understood that the communications network 100 may comprise additional network nodes.

In some embodiments, the first network node 111 may be core network node, such as for example, an AMF.

It may be noted that the use of Network Node in this document may identify one of the following: a logical network node, a physical network node, a function operating within a logical and/or physical network node, and, as depicted in the example of panel d) a service operating within a logical and/or physical network node, that is, within a same network node 114.

The communications network 100 may cover a geographical area, which in some embodiments may be divided into cell areas, wherein each cell area 121 may be served by any of the first network node 111, the second network node 112, the third network node 113, although, one radio network node may serve one or several cells. Any of the plurality of network nodes 110, such as the first network node 111, the second network node 112 and the third network node 113 may be of different classes, such as, e.g., macro base station, home base station or pico base station, based on transmission power and thereby also cell size. Any of the plurality of network nodes 110, such as the first network node 111, the second network node 112 and the third network node 113 may support one or several communication technologies, and its name may depend on the technology and terminology used.

The first network node 111 may be a gNB CU or a gNB DU.

The second network node 112 may be another gNB CU or another gNB DU.

The third network node 113 may be an additional gNB CU or an additional gNB DU.

In some examples, any of the plurality of network nodes 110, such as the first network node 111, the second network node 112 and the third network node 113 may serve receiving nodes with serving beams.

The communication network 100 may comprise one or more wireless devices 130. Any of the one or more wireless devices 130 comprised in the communications network 100 may be a wireless communication device such as a 5G User Equipment (UE) or nUE, or a UE, which may also be known as e.g., mobile terminal, wireless terminal and/or mobile station, a mobile telephone, cellular telephone, or laptop with wireless capability, just to mention some further examples. Any of the one or more wireless devices 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. Any of the one or more wireless devices 130 comprised in the communications network 100 may be enabled to communicate wirelessly in the communications network 100. The communication may be performed e.g., via a RAN, and possibly the one or more core networks, which may be comprised within the communications network 100.

The first network node 111 may be configured to communicate with the second network node 112 over a first link 141, e.g., a wired or wireless link. The second network node 112 may be configured to communicate with any of the one or more wireless devices 130 over a respective second link 142, e.g., a wireless link. Only one such link is depicted in FIG. 1 in order to simplify the figure. The first network node 111 may be configured to communicate with any of the one or more wireless devices 130 over a respective third link 143, e.g., a wireless link. Only one such link is depicted in FIG. 1 in order to simplify the figure. The first network node 111 may be configured to communicate with the third network node 113 over a fourth link 144, e.g., a wired or wireless link. The second network node 111 may be configured to communicate with the third network node 113 over a fifth link 145, e.g., a wired or wireless link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth” and/or “fifth” herein may be understood to be an arbitrary way to denote different elements or entities and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

Embodiments herein may relate to an approach that may be understood to involve a first network node, e.g., a gNB-CU or an Access and Mobility Management Function (AMF), and a second network node, e.g., a gNB-DU or an eNB.

More specifically, the following are embodiments related to a first network node, such as the first network node 111, e.g., a first gNB CU, a gNB CU or an Access and Mobility Management Function (AMF), and a second network node, such as the second network node 112, e.g., a second gNB CU, a gNB-DU or an eNB.

Some embodiments herein will now be further described with some non-limiting examples, which may be combined with the embodiments just described.

In the following description, any reference to a/the first network node and/or a/the first node and/or network node 1 may be understood to equally refer to the first network node 111; any reference to a/the second network node and/or a/the second node and/or network node 2 may be understood to equally refer to the second network node 112; any reference to UEs, and/or the UEs may be understood to equally refer to the one or more wireless devices 130 or to a subset of the one or more wireless devices 130, based on context; any reference to a/the UE may be understood to equally refer to one of the one or more wireless devices 130.

In the following sections, the F1AP may be used as an example to describe the embodiments herein. However, to a person skilled in the art, it may be obvious that the methods described herein may apply to any interface supporting TNLA rebinding of UE signalling connections.

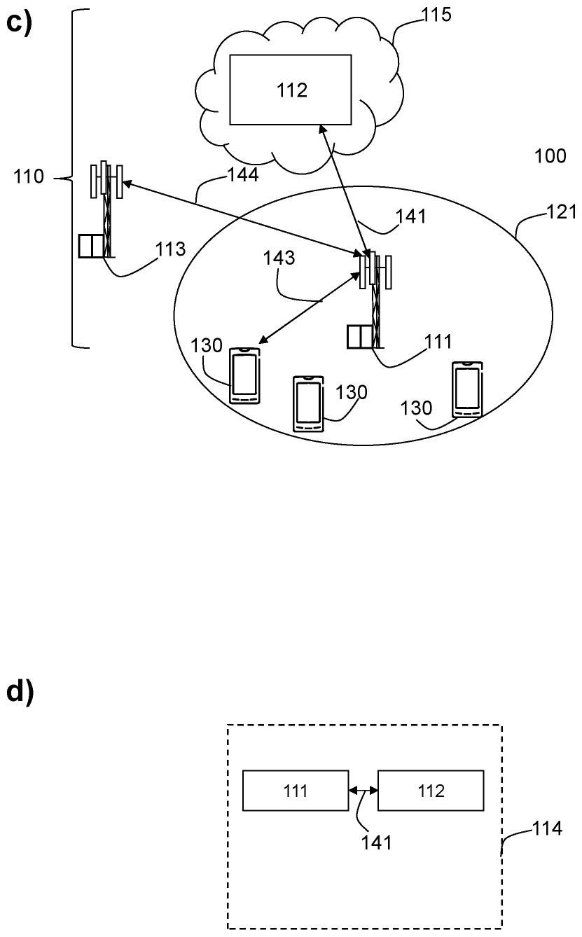

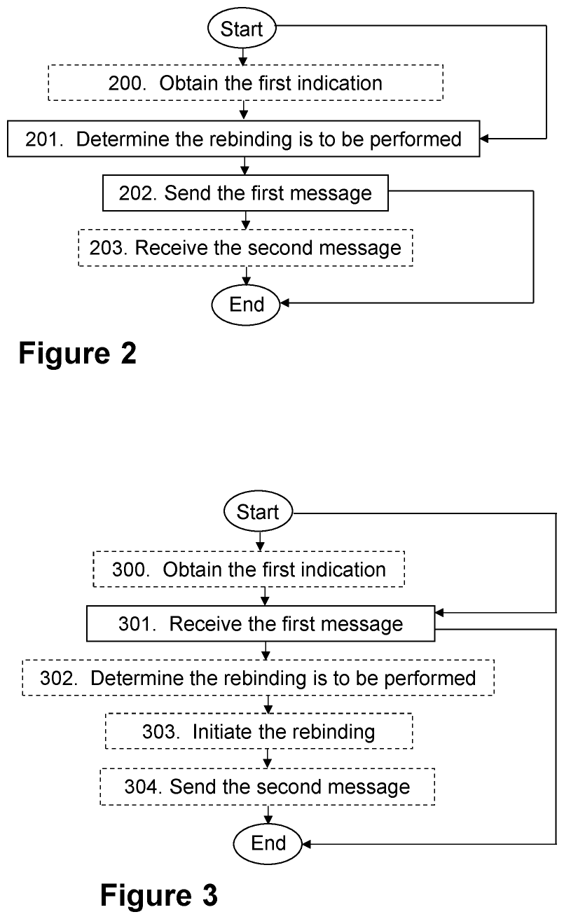

Embodiments of a method, performed by a first network node, such as the first network node 111, will now be described with reference to the flowchart depicted in FIG. 2. The method is for handling one or more connections, e.g., one or more signalling connections. The first network node 111 operates in in a communications network, such as the communications network 100.

In some embodiments, the communications network 100 may be a Cloud RAN network. Several embodiments are comprised herein. The method may comprise two or more of the following actions. In some embodiments all the actions may be performed. In some embodiments, some of the actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first network node 111 is depicted in FIG. 2. In FIG. 2, optional actions in some embodiments may be represented with dashed lines. In some embodiments, the actions may be performed in a different order than that depicted FIG. 2.

In FIG. 2, optional units are indicated with dashed boxes.

### Action 200

In this Action 200, the first network node 111 may obtain a first indication.

The first indication may indicate a respective precedence, or respective priority, of a plurality of first messages received from a plurality of network nodes 110. The first messages in the plurality may be in conflict with each other. In other words, the first indication may indicate a network node 111, 113 of the plurality of network nodes 110 that may have to take precedence in case of conflict between the plurality of first messages received from the plurality of network nodes 110. Expressed differently, the first indication may indicate a respective priority of a respective network node, of the plurality of network nodes 110, wherein the respective priority may be understood to be for a respective precedence of a respective first message of the respective network node of the plurality of network nodes 110, over respective first messages from other network nodes in the plurality of network nodes 110, e.g., which first messages may be in conflict of each other.

To be in conflict with each other may be understood to mean that both network nodes may send the first message within a short time interval, such that the processing of the message sent earliest may not have yet been completed when the message sent later may be sent, and both network nodes may select different TNLAs for the same UE. It may be noted that there could any number of TNLAs, not only two.

The first indication may be a configuration, e.g., a pre-configuration. In one example of embodiments herein, a priority on which of a first or a second node, e.g., but not necessarily, the first network node 111 or another node, such as, e.g., the second network node 112, may take precedence in case of conflicting rebinding indications may be pre-configured at the first and second node.

Binding may be understood herein to refer to deciding or determining which TNLA to use for a UE, that is, one of the one or more wireless devices 130, connecting to the RAN.

Re-binding may be understood herein to refer to deciding or determining which TNLA switch to for a UE, that is, one of the one or more wireless devices 130, already connected to the RAN.

The first indication may be a rebinding priority indication.

The obtaining in this Action 200 may be performed by receiving from the second network node 112, e.g., via the first link 141, or from another network node, e.g., a core network node operating in the communications network 100, or by retrieving from a memory, e.g., within the first network node 111.

### Rebinding Procedure Prioritization

In this method, the priority on which of the nodes, e.g., but not necessarily, the first network node 111 or another node, such as, e.g., the second network node 112, e.g., gNB-DU or gNB-CU, may need to take precedence in case of conflicting rebinding indications may be pre-configured at both nodes involved in the rebinding.

In one example, the specifications may state that, in case of rebinding indication conflicts, the Rebinding procedure triggered by the gNB-CU or AMF may be required to always take precedence over other conflicting rebinding procedures.

In another example, a rebinding priority indication may be signaled over network interface messages and it may be the consequence of pre-configurations on the network nodes.

An example of such signalling is given for the case where the network nodes involved in the rebinding may be gNBs connected over the Xn interface. In the example, a new IE may be added to an exemplary procedure, namely the Xn Setup procedure. Such IE may indicate that the node signalling the IE is the node whose Rebinding Requests may take priority over other conflicting Rebinding Requests.

### Xn Setup Request

This message may be sent by the first network node 111, e.g., a NG-RAN node, to the second network node 112, e.g., a neighbouring NG-RAN node, to transfer application data for an Xn-C interface instance.

Direction: NG-RAN node1→NG-RAN node

| | | | IE type | | | |
|---|---|---|---|---|---|---|
| IE/Group | | | and | Semantics | | Assigned |
| Name | Presence | Range | reference | description | Criticality | Criticality |
| Message | M | | 9.2.3.1 | | YES | reject |
| Type | | | | | | |
| Global | M | | 9.2.2.3 | | YES | reject |
| NG-RAN | | | | | | |
| Node ID | | | | | | |
| TAI | M | | 9.2.3.20 | List of | YES | reject |
| Support | | | | supported | | |
| List | | | | TAs and | | |
| | | | | associated | | |
| | | | | characteristics. | | |
| AMF | M | | 9.2.3.83 | Contains | YES | reject |
| Region | | | | a list of all | | |
| Information | | | | the AMF | | |
| | | | | Regions | | |
| | | | | to which | | |
| | | | | the NG- | | |
| | | | | RAN node | | |
| | | | | belongs. | | |
| List of | | 0 . . . | | Contains | YES | reject |
| Served | | <maxnoofCellsinNG- | | a list of | | |
| Cells NR | | RAN node> | | cells | | |
| | | | | served by | | |
| | | | | the gNB. | | |
| | | | | If a partial | | |
| | | | | list of cells | | |
| | | | | is | | |
| | | | | signalled, | | |
| | | | | it contains | | |
| | | | | at least | | |
| | | | | one cell | | |
| | | | | per carrier | | |
| | | | | configured | | |
| | | | | at the | | |
| | | | | gNB | | |
| >Served | M | | 9.2.2.11 | | — | |
| Cell | | | | | | |
| Information | | | | | | |
| NR | | | | | | |
| >Neighbour | O | | 9.2.2.13 | | — | |
| Information | | | | | | |
| NR | | | | | | |
| >Neighbour | O | | 9.2.2.14 | | — | |
| Information | | | | | | |
| E- | | | | | | |
| UTRA | | | | | | |
| >Served | O | | 9.2.2.102 | | YES | ignore |
| Cell | | | | | | |
| Specific | | | | | | |
| Info | | | | | | |
| Request | | | | | | |
| List of | | 0 . . . | | Contains | YES | reject |
| Served | | <maxnoofCellsinNG- | | a list of | | |
| Cells E- | | RAN node> | | cells | | |
| UTRA | | | | served by | | |
| | | | | the ng- | | |
| | | | | eNB. If a | | |
| | | | | partial list | | |
| | | | | of cells is | | |
| | | | | signalled, | | |
| | | | | it contains | | |
| | | | | at least | | |
| | | | | one cell | | |
| | | | | per carrier | | |
| | | | | configured | | |
| | | | | at the | | |
| | | | | ng-eNB | | |
| >Served | M | | 9.2.2.12 | | — | |
| Cell | | | | | | |
| Information | | | | | | |
| E- | | | | | | |
| UTRA | | | | | | |
| >Neighbour | O | | 9.2.2.13 | | | |
| Information | | | | | | |
| NR | | | | | | |
| >Neighbour | O | | 9.2.2.14 | | — | |
| Information | | | | | | |
| E- | | | | | | |
| UTRA | | | | | | |
| Interface | O | | 9.2.2.39 | | YES | reject |
| Instance | | | | | | |
| Indication | | | | | | |
| TNL | | | 9.2.3.96 | | YES | ignore |
| Configuration | | | | | | |
| Info | | | | | | |
| Partial List | O | | Partial List | Value | YES | ignore |
| Indicator | | | Indicator | “partial” | | |
| NR | | | 9.2.2.46 | indicates | | |
| | | | | that a | | |
| | | | | partial list | | |
| | | | | of cells is | | |
| | | | | included | | |
| | | | | in the List | | |
| | | | | of Served | | |
| | | | | Cells NR | | |
| | | | | IE. | | |
| Cell and | O | | 9.2.2.41 | Contains | YES | ignore |
| Capacity | | | | NR cell | | |
| Assistance | | | | related | | |
| Information | | | | information. | | |
| NR | | | | | | |
| Partial List | O | | Partial List | Value | YES | ignore |
| Indicator | | | Indicator | “partial” | | |
| E-UTRA | | | 9.2.2.46 | indicates | | |
| | | | | that a | | |
| | | | | partial list | | |
| | | | | of cells is | | |
| | | | | included | | |
| | | | | in the List | | |
| | | | | of Served | | |
| | | | | Cells E- | | |
| | | | | UTRA. | | |
| Cell and | O | | 9.2.2.42 | Contains | YES | ignore |
| Capacity | | | | E-UTRA | | |
| Assistance | | | | cell | | |
| Information | | | | related | | |
| E-UTRA | | | | assistance | | |
| | | | | information. | | |
| Local NG- | O | | 9.2.2.101 | | YES | ignore |
| RAN Node | | | | | | |
| Identifier | | | | | | |
| Neighbour | | 0 . . . | | | YES | ignore |
| NG-RAN | | < maxnoofNeighbourNG- | | | | |
| Node List | | RAN nodes> | | | | |
| >Global | M | | 9.2.2.3 | | — | |
| NG-RAN | | | | | | |
| Node ID | | | | | | |
| >Local | M | | 9.2.2.101 | | — | |
| NG-RAN | | | | | | |
| Node | | | | | | |
| Identifier | | | | | | |
| Rebinding | O | | ENUMERATED | Indicates | | |
| Priority | | | (true, . . .) | that the | | |
| | | | | Rebinding | | |
| | | | | procedures | | |
| | | | | triggered | | |
| | | | | by the | | |
| | | | | sending | | |
| | | | | node | | |
| | | | | take | | |
| | | | | priority | | |
| | | | | over | | |
| | | | | other | | |
| | | | | conflicting | | |
| | | | | Rebinding | | |
| | | | | procedures | | |

| Range bound | Explanation |
|---|---|
| maxnoofCellsinNG-RAN node | Maximum no. cells that can |
| | be served by a NG-RAN node. |
| | Value is 16384. |
| maxnoofNeighbourNG-RAN nodes | Maximum no. of neighbour |
| | NG-RAN nodes. Value is 256. |

By in this Action 200 obtaining the first indication indicating the respective precedence of the plurality of first messages received from the plurality of network nodes, the first network node 111 may be enabled to establish prioritization between nodes involved in the TNLA binding, in case of conflicting rebinding indications. This may enable to avoid the synchronization problem of existing methods when both the nodes involved in multiple TNLA configurations may update the binding between a UE signalling connection and a TNLA in case of a failure. That is, the race condition, where each of the two nodes may request a different binding update. As a result of embodiments herein, the procedure of re-binding the UE signalling connection to a new TNLA may be understood to be enabled to converge, preventing a risk of UE disconnections, e.g., UE drop.

### Action 201

In this Action 201, the first network node 111 may determine that a re-binding between one or more connections from one or more wireless devices 130 and a TNLA may have to be performed. That is, the first network node 111 determines that a re-binding between the one or more signalling connections, or one or more first connections, e.g., one or more UE signalling connections, from the one or more wireless devices 130 and the Transport Network Layer Association, TNLA, is to be performed, or may be needed, e.g., from a first TNLA to a second TNLA.

TNLA may be understood to refer to a transport layer connection between two network nodes and their corresponding endpoints.

Determining may be understood as calculating, deriving, or similar.

The signalling connection for a UE, that is, a wireless device 130 of the one or more wireless devices 130, may be understood to refer to a UE-associated communication channel provided by the TNLA when the wireless device 130, e.g., UE may have been bound to it. The “signalling connection” or “communication channel” or “UE associated signalling TNLA” may be understood to be different terms used in an equivalent manner, may be used carry out, e.g., UE Context Management, RRC Message Transfer and Trace procedures regarding a wireless device 130, e.g., UE in question. A procedure may comprise a single message or an initiating message and a response message.

For each pair of communicating network nodes, one or more TNLAs may be established. In normal operation, several UEs may be bound to each TNLA.

There may be a need to bind a part of, or all, UEs of a TNLA to another one in several cases, including, but not limited to: i) TNLA failure, e.g., failures of the transport connection supporting the TNLA, ii) internal errors, especially in cloud implementations, e.g., errors to functions or microservices receiving and generating the content of UE-Associated interface messages, iii) load balancing of UEs, and iv) graceful TNLA shutdown. This may enable fast in-service upgrade for cloud implementations.

In some embodiments, the determining 201 may be based on, e.g., triggered by or subsequent to, at least one of: a) a failure of the first TNLA; in some of such embodiments the rebinding may be to a working TNLA, b) after an internal error, e.g., at the first network node 111, for example, a temporary internal error, e.g., a failure of a service instance or a physical node, c) an overload situation, e.g., therefore, as part of a load balancing procedure, d) a TNLA shutdown, e.g., a shutdown of the first TNLA, e) an XN setup request, f) a network connectivity issue, and g) a service upgrade.

The determining in Action 201 may be based on the obtained first indication. In other words, the first indication may indicate a network node 111, 113 of the plurality of network nodes 110 that may have to take precedence in case of conflict between the plurality of first messages received from the plurality of network nodes 110.

By determining that a re-binding between the one or more signalling connections, from the one or more wireless devices 130 and the TNLA is to be performed in this Action 201, the first network node 111 may enable that the one or more wireless devices 130 may instantly be bound to another TNLA. For example, the first network node 111 may enable that a UE TNLA change may no longer have to wait until there may be a meaningful procedure to initiate, which may lead to rebinding delays. The first network node 111 may enable to avoid having to force a procedure e.g., sent even if there may be no need for it, just for the sake of carrying out the rebinding, and thereby avoid that there may be side effects that may lead to bad configurations.

The first network node 111 may further enabled avoiding having to wait for all the UEs to disconnect on their own initiative to empty a TNLA, which may be understood to take a long time.

### Action 202

In this Action 202, the first network node 111 sends, to the second network node 112 operating in the communications network 100, a first message. The first message indicates that the re-binding is to be performed. The first message further indicates how the re-binding is to be performed. That is, in this Action 202, the first network node 111 triggering the TNLA rebinding may signal to the second network node 112 the first message including information that may allow the receiving node to determine how the one or more UE signalling connections may need to be rebound to a new TNLA.

### The Rebind Procedure

The first message is a dedicated message. That the first message is a dedicated message may be understood to mean that the first message may be understood to be dedicated to the rebinding function, that is, the first message may be understood to only have the function of rebinding. In this example of embodiments herein, a dedicated rebind procedure may be used to perform the rebinding of the one or more wireless devices 130, e.g., the UEs, signalling connections to a TNLA.

One of the following options applies: a) the first message indicates to which TNLA the one or more wireless devices 130 are to be rebound, e.g., the second TNLA the one or more wireless devices 130 may have to be rebound to, and b) the first message is sent over the TNLA to which the one or more wireless devices 130 are to be rebound, e.g., may be sent over the second TNLA.

The sending in this Action 202 may be, e.g., via the first link 141.

The first message may be a first rebind message, e.g., a rebind request.

In some examples, the first message may be, e.g., an internal rebind message.

In some embodiments, one of the following options may apply. According to a first option, the first message may indicate a list of one or more identifiers; the one or more identifiers may identify the one or more wireless devices 130 that may have to be rebound, and to which TNLA the one or more wireless devices 130 may have to be rebound, e.g., the second TNLA the one or more wireless devices 130 may have to be rebound to. In one example of embodiments herein, the first message may contain a list of UE identifiers and to which TNLA those UEs may need to be rebound.

In an example of embodiments herein, the rebind procedure may be initiated on another TNLA than the one where the UEs may be going to be rebound. In this case, the REBIND REQUEST, message may contain a mapping of the TNLA endpoints identifying the TNLA to which the UEs may need to be rebound and a list of application protocol IDs identifying the UEs that may need to be rebound to the indicated TNLA.

According to a second option, the first message may indicate the list of the one or more identifiers; the first message may be sent over the TNLA to which the one or more wireless devices 130 may have to be rebound, e.g., may be sent over the second TNLA. In another example of embodiments herein, the first message may only contain a list of UE identifiers. The message may be signalled to the receiving node over the TNLA where the rebinding may need to occur.

In one example of embodiments herein, the REBIND REQUEST, message may be signaled over the TNLA where the UEs indicated by the message may be going to be rebound. The REBIND REQUEST, message may contain a list of Application Protocol (AP) UE IDs, which may identify the UEs to be bound to the TNLA where the message may be signaled.

According to a third option, the first message may be, e.g., associated to a respective wireless device of the one or more wireless devices 130. In another example of embodiments herein, the message may be a new UE associated message, namely associated to the UE for which the rebinding may need to occur, such message being dedicated to the rebinding function. One of the following options may further apply to the third option: a) the first message may indicate to which TNLA the one or more wireless devices 130 may have to be rebound, e.g., the second TNLA the one or more wireless devices 130 may have to be rebound to, and b) the first message may be sent over the TNLA to which the one or more wireless devices 130 may have to be rebound, e.g., may be sent over the second TNLA. In yet another example, the first message may either contain the TNLA where the UE signalling connection may need to be rebound, or it may be signalled over the TNLA where the UE signalling connection may need to be rebound.

In another example of embodiments herein the rebinding message may be a UE associated message. This message may implicitly state that the UE subject to rebinding is the UE associated to the signalling connection the message belongs to. As per previous examples, the message may either be signaled directly on the TNLA where the UE may be rebound or on a different TNLA.

Examples of how the REBIND MESSAGE may be implemented are shown below, taking the F1 as the interface of reference.

Example of REBIND REQUEST Over the TNLA where the Rebinding Occurs

### Rebind Request

This message may be sent by both the first network node 111, e.g., the gNB-CU, and the second network node 112, e.g., the gNB-DU, and may be used to indicate that one or more UE signalling connections may be rebound to the TNLA where the message may be signaled.

Direction: gNB-CU→gNB-DU and gNB-DU→gNB-CU.

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | ignore |
| Transaction ID | M | | 9.3.1.23 | | YES | reject |
| UE Rebinding | | 1 | | | EACH | reject |
| List | | | | | | |
| >UE Rebinding | | 1 . . . | | | | |
| Item | | < maxnoofReboundUEs> | | | | |
| >>gNB-CU UE | O | | 9.3.1.4 | | YES | reject |
| F1AP ID | | | | | | |
| >>gNB-DU UE | O | | 9.3.1.5 | | YES | reject |
| F1AP ID | | | | | | |
| Criticality | O | | 9.3.1.3 | | YES | ignore |
| Diagnostics | | | | | | |

In the above tabular, both the gNB-CU UE F1AP ID and gNB-DU UE F1AP ID are included in the message. However, their presence may be either mandatory for both IEs or optional for both IEs. If the presence is mandatory for both IEs, the IEs may always be present in the message. If the presence is optional, then the ID corresponding to the receiving node may need to be present. Namely, if the receiving node is a gNB-DU, the gNB-DU UE F1AP ID may be present.

Example of REBIND REQUEST Over a Generic TNLA, where the Rebinding May not Necessarily Occur

### Rebind Request

This message may be sent by both the first network node 111, e.g., the gNB-CU, and the second network node 112, e.g., the gNB-DU, and may be used to indicate that one or more UE signalling connections may be rebound to a specific TNLA.

Direction: gNB-CU→gNB-DU and gNB-DU→gNB-CU.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| Transaction ID | M | | 9.3.1.23 | | YES | reject |
| Rebind TNL | | 1 | | | YES | reject |
| Association List | | | | | | |
| > Rebind TNL | | 1 . . . | | | EACH | |
| Association Item | | < maxnoofTNLAssociations> | | | | |
| >>TNL | M | | CP | Transport | — | — |
| Association | | | Transport | Layer | | |
| Transport Layer | | | Layer | Address of | | |
| Address | | | Address | the gNB- | | |
| | | | 9.3.2.4 | DU. | | |
| >>TNL | M | | CP | Transport | — | — |
| Association | | | Transport | Layer | | |
| Transport Layer | | | Layer | Address of | | |
| Address gNB-CU | | | Address | the gNB- | | |
| | | | 9.3.2.4 | CU | | |
| >>UE Rebinding | | 1 | | | EACH | reject |
| List | | | | | | |
| >>>UE | | 1 . . . | | | | |
| Rebinding Item | | < maxnoofReboundUEs> | | | | |
| >>>>gNB-CU UE | O | | 9.3.1.4 | | YES | reject |
| F1AP ID | | | | | | |
| >>>>gNB-DU UE | O | | 9.3.1.5 | | YES | reject |
| F1AP ID | | | | | | |
| Criticality | O | | 9.3.1.3 | | YES | ignore |
| Diagnostics | | | | | | |

In the above tabular, the TNLA to which the UEs identified by the F1AP IDs may need to be rebound may be indicated by means of the TNLA transport layer address for both endpoints. The endpoints may consist of an IP address or of both an IP address and port number. With respect to the F1AP IDs, the same as in the previous example may apply.

Example of UE Associated REBIND REQUEST Over the TNLA where the Rebinding Occurs

### Rebind Request

This message may be sent by both the first network node 111, e.g., the gNB-CU, and the second network node 112, e.g., the gNB-DU, and may be used to indicate that the UE's signalling connections is rebound to the TNLA where the message is signaled.

Direction: gNB-CU→gNB-DU and gNB-DU→gNB-CU

| | | | IE type | | | |
|---|---|---|---|---|---|---|
| IE/Group | | | and | Semantics | Criti- | Assigned |
| Name | Presence | Range | reference | description | cality | Criticality |
| Message | M | | 9.3.1.1 | | YES | reject |
| Type | | | | | | |
| gNB-CU UE | M | | 9.3.1.4 | | YES | reject |
| F1AP ID | | | | | | |
| gNB-DU UE | M | | 9.3.1.5 | | YES | ignore |
| F1AP ID | | | | | | |

As stated earlier, the first indication may be a configuration, e.g., a pre-configuration. In a depending example, the configuration may determine that the first message signalled by a specific network node, e.g., a gNB-CU or an AMF, may need to always take precedence over a first message signalled by other nodes, e.g., a gNB-DU or a gNB. Namely, if first and second node send at the same time or within a limited time window both the first message, the configuration may determine which of these messages may need to be: a) be prioritized and eventually trigger a successful rebinding and which of such messages may need to be followed by a failure message; b) in a depending example, the configuration on which node may take priority when deciding which of the first messages signalled by the first and second node may need to be considered for a potentially successful re-binding may be signalled as per the messages exchanged between first and second node for the setup and configuration update of the interface connecting them. As an example, if the first and second node are gNBs and the interface connecting them is the XnAP, this information may be signalled as part of the Xn Setup procedure messages.

By sending the first message indicating that the re-binding is to be performed, and how the re-binding is to be performed, in a dedicated message in this Action 202, the first network node 111 may enable an explicit procedure for updating the TNLA bindings of the one or more wireless devices 130, e.g., the UE TNLA bindings.

By introducing a UE TNLA rebind procedure, a set of the one or more wireless devices 130, e.g., UEs, may instantly be bound to another TNLA. This may be understood to enable keeping the sessions of the one or more wireless devices 130, e.g., UE sessions, during, e.g.: failures on interface level, internal errors, and termination of TNLAs. It may also enable load-balancing of the one or more wireless devices 130, e.g., UEs, and minimize the risk of conflicting rebind decisions between the communicating network nodes.

One advantage may be understood to be that in case of a failure, the UE TNLA binding may immediately be synchronized between the first network node 111 and the second network node 112.

Another advantage may be understood to be that in a cloud implementation with separate microservices for interface handling and UE handling, internal communication errors may be mitigated by rebinding the UEs to a working path through the system.

Yet another advantage may be understood to be that if a TNLA is to be removed, the UEs bound to it may be retained and it may be explicitly specified to which TNLA the UEs may need to be rebound. For a cloud implementation, this graceful TNLA removal may be applied when the microservice instance terminating the TNLA may need to be upgraded.

A further advantage may be understood to be that with a rebind procedure the semantics may be clearer, rather than having the TNLA UE rebinding as a side-effect of another UE associated procedure.

### Action 203

In this Action 203, the first network node 111 may receive, from the second network node 112, a second message.

The receiving in this Action 203 may be e.g., via the first link 141.

The second message may indicate whether or not the re-binding was successful.

In some examples, the second message may the list of one or more identifiers; the one or more identifiers may identify the one or more wireless devices 130 that may have been successfully rebound.

In some examples, the second message may be a rebind acknowledge message.

The second message may indicate one of the following a) successful re-binding of the one or more wireless devices 130, b) successful re-binding of a first subset of the one or more wireless devices 130 and failed re-binding of a second subset of the one or more wireless devices 130, c) successful re-binding of the first subset of the one or more wireless devices 130, failed re-binding of the second subset of the one or more wireless devices 130, and an indication that a further re-binding procedure for the second set may have to be initiated, d) successful re-binding of the first subset of the one or more wireless devices 130, failed re-binding of the second subset of the one or more wireless devices 130, the indication that a further re-binding procedure for the second set may have to be initiated, and a further indication indicating a cause of the failed re-binding, e) failed re-binding of the one or more wireless devices 130, f) failed re-binding of the one or more wireless devices 130, and the further indication indicating the cause of the failed re-binding, and g) failed re-binding of one or more of the one or more wireless devices 130, and an additional indication indicating a back-off timer; the back-off timer may indicate a time before which the first network node 111 may have to not initiate a new re-binding procedure.

The second message may be a second rebind message, e.g., a rebind response, such as a rebind failure message, a rebind acknowledge message.

For both examples described above, in relation to the first and second options of the rebind message, the REBIND REQUEST may be either followed by a REBIND RESPONSE confirming the successful rebinding of UEs to the target TNLA or by a REBIND FAILURE, which may be understood to confirm failure to rebind any of the indicated UEs to the target TNLA.

In another example of embodiments herein, the rebind procedure may occur as per one of the two examples above, but the REBIND RESPONSE may list UEs for which the rebinding actions did not succeed.

In another example of embodiments herein, the rebind procedure may occur as per one of the two examples described above, in relation to the first and second options of the rebind message, but, in case one or more UE signalling connections fails to rebind, a REBIND FAILURE message may be issued. The REBIND FAILURE message may include a random backoff timer, namely a time length before which the node receiving the failure message may not initiate a new rebinding procedure.

In one example of embodiments herein, in case of conflicting rebinding indications, namely if first and second node, e.g., but not necessarily, the first network node 111 or another node, such as, e.g., the second network node 112, send at the same time or within a limited time window both the first message, both the first and second node may reply to the first message with a failure message.

In a depending example, the failure message may contain a random backoff timer, namely a time length before which the node receiving the failure message may not initiate a new rebinding procedure. Assuming that the backoff timers chosen by first and second nodes, e.g., but not necessarily, the first network node 111 or another node, such as, e.g., the second network node 112, are different, such approach may ensure that there may no longer be a situation of conflict in rebinding indications.

In a depending example, after reception of the failure message, it may be left to the first and second node implementation, e.g., but not necessarily, the first network node 111 or another node, such as, e.g., the second network node 112, how and when to re-trigger a rebinding indication.

Example of REBIND RESPONSE with List of UEs that Failed to Rebind.

### Rebind Response

This message may be sent by both the gNB-CU and the gNB-DU and may be used to acknowledge that at least one or more UE signalling connections may be rebound to the TNLA where the message may be signaled.

Direction: gNB-CU→gNB-DU and gNB-DU→gNB-CU

| | | | IE type | | | |
|---|---|---|---|---|---|---|
| IE/Group | | | and | Semantics | | Assigned |
| Name | Presence | Range | reference | description | Criticality | Criticality |
| Message | M | | 9.3.1.1 | | YES | ignore |
| Type | | | | | | |
| Transaction | M | | 9.3.1.23 | | YES | reject |
| ID | | | | | | |
| UE Failed | | 1 | | List of UEs for | EACH | reject |
| to | | | | which the | | |
| Rebinding | | | | rebinding of the | | |
| List | | | | UE signalling | | |
| | | | | connection did | | |
| | | | | not succeed | | |
| >UE Failed | | 1 . . . | | | | |
| to Rebind | | < maxnoofReboundUEs> | | | | |
| Rebinding | | | | | | |
| Item | | | | | | |
| >>gNB-CU | O | | 9.3.1.4 | | YES | reject |
| UE F1AP | | | | | | |
| ID | | | | | | |
| >>gNB-DU | O | | 9.3.1.5 | | YES | reject |
| UE F1AP | | | | | | |
| ID | | | | | | |
| >>Cause | | | 9.3.1.2 | Indicates the | YES | ignore |
| | | | | cause for which | | |
| | | | | the rebinding | | |
| | | | | failed | | |
| Criticality | 0 | | 9.3.1.3 | | YES | ignore |
| Diagnostics | | | | | | |

Example of REBIND FAILURE with Rebind Backoff Time

### Rebind Response

This message may be sent by both the gNB-CU and the gNB-DU and may be used to indicate rebind failure.

Direction: gNB-CU→gNB-DU and gNB-DU→gNB-CU.

| | | | IE type | | | As- |
|---|---|---|---|---|---|---|
| IE/Group | | | and | Semantics | Criti- | signed |
| Name | Presence | Range | reference | description | cality | Critical |
| Message | M | | 9.3.1.1 | | YES | ignore |
| Type | | | | | | |
| Trans- | M | | 9.3.1.2 | | YES | reject |
| action ID | | | 3 | | | |
| Rebinding | | | INTEGER | The duration of | YES | reject |
| Backoff | | | (0 . . . 4095) | the backoff time | | |
| Time | | | | during which a | | |
| | | | | new Rebinding | | |
| | | | | procedure is not | | |
| | | | | triggered, in | | |
| | | | | milliseconds. | | |
| Criticality | O | | 9.3.1.3 | | YES | ignore |
| Diagnos- | | | | | | |
| tics | | | | | | |

By receiving the second message from the second network node 112 in this Action 203, the first network node 111 may be enabled to get confirmation that the rebinding was successful and if not, to be given the opportunity to act on the failure, or partial failure of the rebinding, so that rebinding may be ultimately enabled to be achieved.

Embodiments of a method, performed by a second network node, such as the second network node 112, will now be described with reference to the flowchart depicted in FIG. 3. The method may be understood to be for handling the one or more connections, e.g., the one or more signalling connections. The second network node 112 operates in a communications network, such as the communications network 100.

Several embodiments are comprised herein. The method may comprise one or more of the following actions. In some embodiments, all the actions may be performed. It should be noted that the examples herein are not mutually exclusive. One or more embodiments may be combined, where applicable. All possible combinations are not described to simplify the description. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second network node 112 is depicted in FIG. 3. In FIG. 3, optional actions in some embodiments may be represented with dashed lines. In some embodiments, the actions may be performed in a different order than that depicted FIG. 3. The detailed description of some of the following corresponds to the same references provided above, in relation to the actions described for the first network node 111 and will thus not be repeated here to simplify the description. For example, in some embodiments, the communications network 100 may be a Cloud RAN network.

The examples for the first network node 111 comprising the second network node 112 may be understood to be mirrored for the second network node 112.

In FIG. 3, optional units are indicated with dashed boxes.

### Action 300

In this Action 300, the second network node 112 may obtain the first indication.

The obtaining in this Action 300 may be performed by receiving from the first network node 111, e.g., via the first link 141, or from another network node, e.g., a core network node operating in the communications network 100, or by retrieving from a memory, e.g., within the second network node 112.

The first indication may indicate the respective precedence, or respective priority, of the plurality of first messages received from the plurality of network nodes 110. The first messages in the plurality may be in conflict with each other. In other words, the first indication may indicate the network node 111, 113 of the plurality of network nodes 110 that may have to take precedence in case of conflict between the plurality of first messages received from the plurality of network nodes 110. Expressed differently, the first indication may indicate the respective priority of the respective network node, of the plurality of network nodes 110, wherein the respective priority may be understood to be for the respective precedence of the respective first message of the respective network node of the plurality of network nodes, over the respective first messages from other network nodes in the plurality of network nodes 110, e.g., which first messages may be in conflict of each other.

### Action 301

In this Action 301, the second network node 112 receives the first message.

The receiving in this Action 301 is from the first network node 111 operating in the communications network 100.

The first message indicates that the re-binding is to be performed.

The re-binding is between the one or more connections, or the one or more first connections, e.g., the one or more signalling connections, from the one or more wireless devices 130 and the TNLA. That is, the first network node 111 may determine that the re-binding between the one or more signalling connections from the one or more wireless devices 130 and the TNLA may have to be performed, e.g., from the first TNLA to the second TNLA.

The first message further indicates how the re-binding is to be performed.

The first message is the dedicated message, and one of the following applies: a) the first message indicates to which TNLA the one or more wireless devices 130 are to be rebound, e.g., the second TNLA the one or more wireless devices 130 may have to be rebound to, and b) the first message is received over the TNLA to which the one or more wireless devices 130 are to be rebound, e.g., may be received over the second TNLA.

The receiving in this Action 301 may be performed, e.g., via the first link 141.

In some embodiments, one of the following options may apply. According to a first option, the first message may indicate the list of the one or more identifiers; the one or more identifiers may identify the one or more wireless devices 130 that may have to be rebound; the first message may further indicate to which TNLA the one or more wireless devices 130 may have to be rebound, e.g., the second TNLA the one or more wireless devices 130 may have to be rebound to. According to a second option, the first message may indicate the list of the one or more identifiers; the first message may be received over the TNLA to which the one or more wireless devices 130 may have to be rebound, e.g., may be received over the second TNLA. According to a third option, the first message may be associated to a respective wireless device of the one or more wireless devices 130.

### Action 302

In some embodiments, in this Action 302, the second network node 112 may determine that the re-binding between the one or more connections, e.g., the one or more signalling connections, from the one or more wireless devices 130 and the TNLA, e.g., the second TNLA, may have to be performed.

The determining in Action 302 may be based on the obtained first message. Upon receiving the first message, the second network node 112 may determine that the UE signalling connection described in the first message may need to be rebound to the TNLA indicated either implicitly or explicitly with the first message. From this moment on, the second network node 112 may send signalling messages associated to the one or more wireless devices 130, e.g., the one or more UEs, for which rebinding occurred on the newly selected TNLA.

The determining in Action 302 may be based on the obtained first indication.

### Action 303

In some embodiments, in this Action 303, the second network node 112 may initiate the re-binding.

The re-binding may be between the one or more signalling connections from the one or more wireless devices 130 and the TNLA, e.g., the second TNLA.

The initiating in this Action 303 may be understood as starting, triggering, or enabling.

### Action 304

In this Action 304, the second network node 112 may send the second message.

The sending in this Action 304 may be to the first network node 111.

The second message may indicate whether or not the re-binding was successful.

The second message may indicate one of the following: a) successful re-binding of the one or more wireless devices 130, b) successful re-binding of the first subset of the one or more wireless devices 130 and failed re-binding of the second subset of the one or more wireless devices 130, c) successful re-binding of the first subset of the one or more wireless devices 130, failed re-binding of the second subset of the one or more wireless devices 130, and the indication that the further re-binding procedure for the second set may have to be initiated, d) successful re-binding of the first subset of the one or more wireless devices 130, failed re-binding of the second subset of the one or more wireless devices 130, the indication that the further re-binding procedure for the second set may have to be initiated, and the further indication indicating the cause of the failed re-binding, e) failed re-binding of the one or more wireless devices 130, f) failed re-binding of the one or more wireless devices 130, and the further indication indicating the cause of the failed re-binding, and g) failed re-binding of the one or more of the one or more wireless devices 130, and the additional indication indicating the back-off timer; the back-off timer may indicate the time before which the first network node 111 may have to not initiate the new re-binding procedure.

In one example of embodiments herein, the second network node 112 may respond to the first message with the second message. In a depending example, the second message may confirm successful rebinding between the one or more UE signalling connections and the TNLA indicated via the first message. In another depending example, the second message may confirm the successful rebinding of some of the UE signalling connections listed in the first message. The second message may also include a list of UE signalling connections that failed to be rebound and for which a new rebinding procedure may have to be triggered. For each UE signalling connection that failed to rebound, a description of a cause indicating why the failure occurred may be included. In yet another depending example, the second message may indicate failure to rebind any of the UE signalling connection indicated in the first message. A cause indicating why the failure occurred may be included.

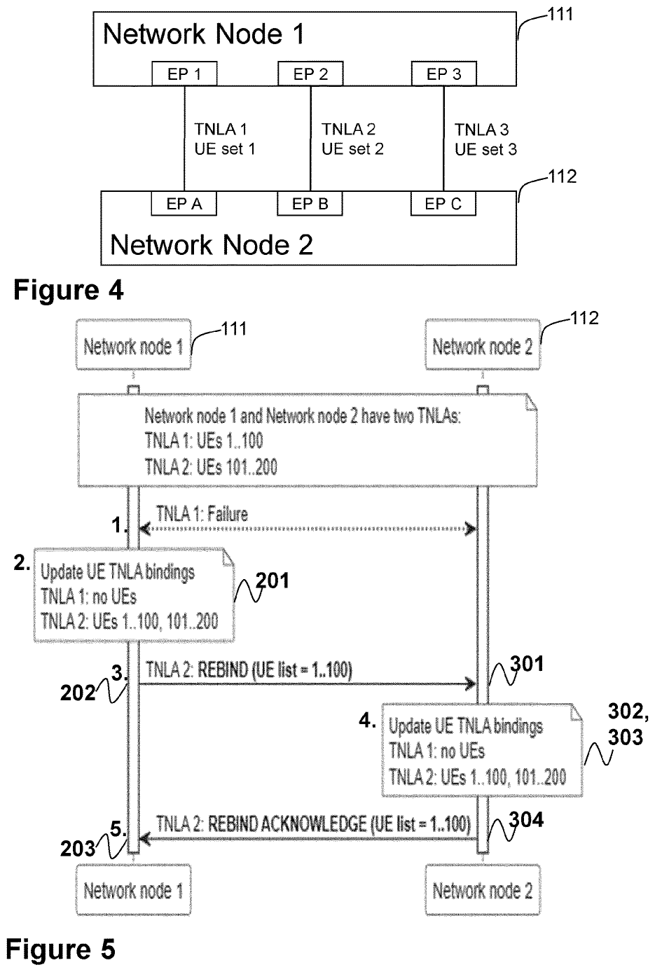

FIG. 4 is a block diagram of endpoint separation and UE distribution. As stated earlier, for each pair of communicating network nodes, one or more TNLAs may be established. FIG. 4 depicts the first network node 111, or network node 1, and the second network node 112, or network node 2. In the non-limiting example of FIG. 4, three different TNLAS, TNLA 1, TNLA 2 and TNLA 3 are established between the first network node 111 and the second network node 112. In normal operation, several UEs may be bound to each TNLA, described as e.g., UE set 1, UE set 2 and UE set 3 in the figure, bound respectively to TNLA 1, TNLA 2 and TNLA 3. FIG. 4 illustrates one way of distributing the TNLAs over several endpoints. Particularly, TNLA 1, TNLA 2 and TNLA 3 are established, respectively, between Endpoint (EP) 1, EP2, and EP3 of the first network node 111, and EP 1, EP B and EP C of the second network node 112.

As explained earlier, there may be a need to bind a part of, or all, of the one or more wireless devices 130, of a TNLA to another one in several cases, including, but not limited to: i) TNLA failure, e.g., failures of the transport connection supporting the TNLA, ii) internal errors, especially in cloud implementations, e.g., errors to functions or microservices receiving and generating the content of UE-Associated interface messages, iii) load balancing of UEs, and iv) graceful TNLA shutdown. This may enable fast in-service upgrade for cloud implementations. A description of examples of each of these are illustrated next.

### TNLA Failure

FIG. 5 is a signalling diagram depicting a non-limiting example of a method performed in a communications network 100, according to embodiments herein. FIG. 5 particularly illustrates a sequence diagram of TNLA failure handling. If there is a failure of a TNLA, the one or more wireless devices 130, e.g., UEs, may be rebound to a working TNLA, as depicted in FIG. 5. Although existing technology may allow for both network nodes to update the UE TNLA binding upon failure, embodiments herein may allow for a timely and synchronized switching of all affected one or more wireless devices 130, e.g., UEs, in one procedure. In FIG. 5, the first network node 111 is depicted as Network node 1, and the second network node 112 is depicted as Network node 2. The one or more wireless devices 130, are UEs. In an initial state, Network node 1 and Network node 2 have two TNLAs: TNLA 1 with UEs 1 to 100 and TNLA 2 with UEs 101 to 200. At 1, TNLA 1 fails. At 2, according to Action 201, Network node 1 may internally rebind the UEs of TNLA 1 to TNLA 2, UEs 1 to 100. That is, Network node 1 may update the UE TNLA bindings, so that TNLA 1 is left with no UEs and TNLA 2 is left with UEs 1 . . . 100, 101 . . . 200. At 3, according to Action 202 and Action 301, Network node 1 may send the REBIND message to Network node 2 over TNLA 2. The REBIND message indicates a UE list of 1 . . . 100. At 4, according to Action 302 and Action 303, Network node 2 may internally rebind the UEs of TNLA 1 to TNLA 2, UEs 1 to 100. That is, Network node 2 may update the UE TNLA bindings, so that TNLA 1 is left with no UEs and TNLA 2 is left with UEs 1 . . . 100, 101 . . . 200. At 5, according to Action 304 and Action 203, Network node 2 may send the REBIND ACKNOWLEDGE message to Network node 1 over TNLA 2. The second message may comprise the UE list including UE 1 to UE 100. For this case, all the examples described in relation to FIGS. 2 and 3, e.g., in the Sections under the heading “The Rebind Procedure”, may be applied. After, or in parallel to, the rebind procedure, Network node 1 may initiate the less time-critical process of adding of new TNLA(s) replacing the failed TNLA.

### Internal Error

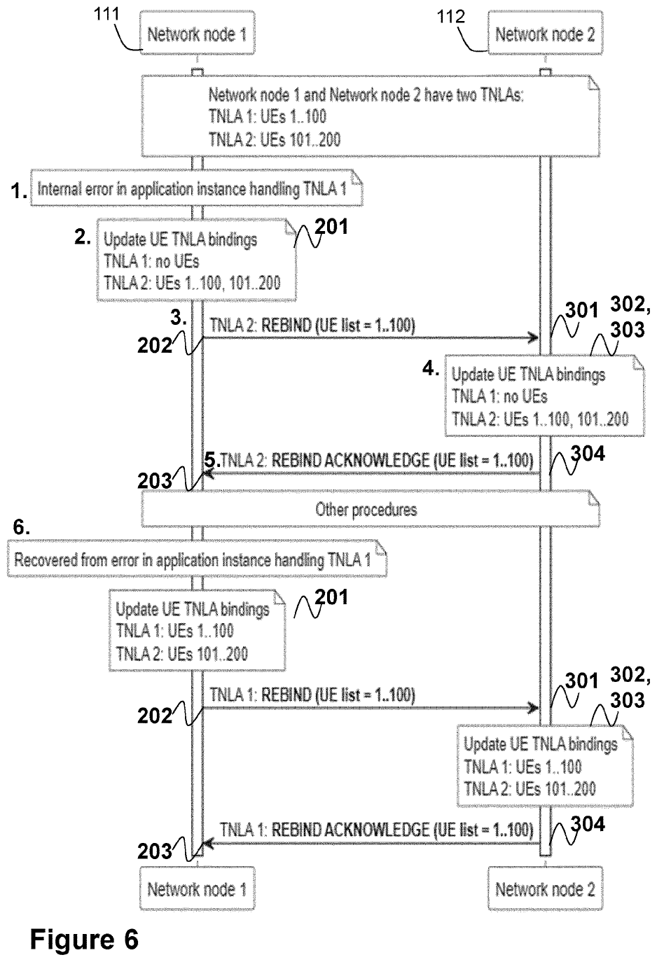

FIG. 6 is a signalling diagram depicting another non-limiting example of a method performed in a communications network 100, according to embodiments herein. FIG. 6 particularly illustrates a sequence diagram of internal error handling. If a network node encounters an internal error in the application handling a TNLA, it may rebind those one or more wireless devices 130, e.g., UEs, to another, working, path through the system. In FIG. 6, the entities depicted are the same as in FIG. 5. In an initial state, Network node 1 and Network node 2 have two TNLAs: TNLA1 with UEs 1 to 100 and TNLA2 with UEs 101 to 200. At 1, the Network node 1 application instance handling TNLA1 encounters a temporary internal error. At 2, according to Action 201, Network node 1 may internally rebind the UEs of TNLA1 to TNLA2, UEs 1 to 100. That is, Network node 1 may update the UE TNLA bindings, so that TNLA 1 is left with no UEs and TNLA 2 is left with UEs 1 . . . 100, 101 . . . 200. At 3, according to Action 202 and Action 301, Network node 1 may send the REBIND message to Network node 2 over TNLA2. The REBIND message indicates a UE list of 1 . . . 100. At 4, according to Action 302 and Action 303, Network node 2 may internally rebind the UEs of TNLA1 to TNLA2, UEs 1 to 100. That is, Network node 2 may update the UE TNLA bindings, so that TNLA 1 is left with no UEs and TNLA 2 is left with UEs 1 . . . 100, 101 . . . 200. At 5, according to Action 304 and Action 203, Network node 2 may send the REBIND ACKNOWLEDGE message to Network node 1 over TNLA2. The second message may comprise the UE list including UE 1 to UE 100. At 6. After the Network node 1 may have recovered from the internal failure, according to Action 201, it may once again bind UEs to TNLA1. The same sequence described in steps 2-5 may then be repeated, but for the rebinding of the UEs to TNLA1. For this case, all the examples described in relation to FIGS. 2 and 3, e.g., in in the Sections under the heading “The Rebind Procedure”, may be applied

### Load Balancing

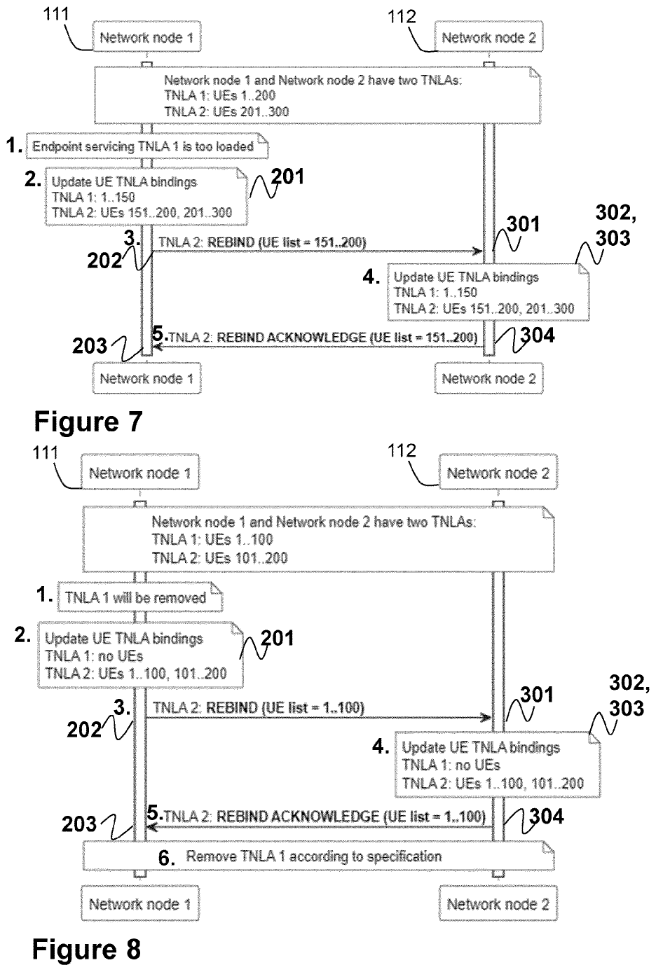

FIG. 7 is a signalling diagram depicting another non-limiting example of a method performed in a communications network 100, according to embodiments herein. FIG. 7 particularly illustrates a sequence diagram of UE TNLA load balancing. The rebind procedure may be used to balance the UEs among existing TNLAs, as depicted in FIG. 7. The reason to do so may mainly be a high load on a network node application instance servicing an endpoint (EP). It may be kept in mind that a network node endpoint may be connected to many other network nodes, e.g., a gNB-CU endpoint may service many gNB-DUs. In FIG. 6, the entities depicted are the same as in FIG. 5. In an initial state, Network node 1 and Network node 2 have two TNLAs: TNLA 1 with UEs 1 to 200 and TNLA 2 with UEs 201 to 300. At 1, the Network node 1 application instance handling TNLA 1 is overloaded. At 2, according to Action 201, Network node 1 may determine that UEs 151 to 200 may need to be offloaded from TNLA 1 to TNLA 2. Network node 1 may update the UE TNLA bindings, so that TNLA 1 is left with UEs 1 . . . 150 and TNLA 2 is left with UEs 152 . . . 200, 201 . . . 300. At 3, according to Action 202 and Action 301, Network node 1 may send the REBIND message to Network node 2 over TNLA 2. The REBIND message indicates a UE list of 151 . . . 200. At 4, according to Action 302 and Action 303, Network node 2 may internally rebind the UEs 151 to 200 from TNLA 1 to TNLA 2. That is, Network node 2 may update the UE TNLA bindings, so that TNLA 1 is left with UEs 1 . . . 150 and TNLA 2 is left with UEs 152 . . . 200, 201 . . . 300. At 5, according to Action 304 and Action 203, Network node 2 may send the REBIND ACKNOWLEDGE message to Network node 1 over TNLA 2. The second message may comprise the UE list including UE 151 . . . 200. For this case, all the examples described in relation to FIGS. 2 and 3, e.g., in in the Sections under the heading “The Rebind Procedure” may be applied

### TNLA Shutdown

FIG. 8 is a signalling diagram depicting another non-limiting example of a method performed in a communications network 100, according to embodiments herein. FIG. 8 particularly illustrates a sequence diagram of TNLA shutdown. If an endpoint has a high number of TNLAs or if a TNLA is deemed as redundant, the first network node 111 may first rebind the UEs before closing the TNLA or asking the other network node, e.g., the second network node 112, to remove it, as depicted in FIG. 8. In FIG. 8, the entities depicted are the same as in FIG. 5. In an initial state, Network node 1 and Network node 2 have two TNLAs: TNLA 1 with UEs 1 to 100 and TNLA 2 with UEs 101 to 200. At 1, Network node 1 may determine that TNLA 1 will be removed. At 2, according to Action 201, Network node 1 may internally rebind the UEs of TNLA 1 to TNLA 2, UEs 1 to 100. That is, Network node 1 may update the UE TNLA bindings, so that TNLA 1 is left with no UEs and TNLA 2 is left with UEs 1 . . . 100, 101 . . . 200. At 3, according to Action 202 and Action 301, Network node 1 may send the REBIND message to Network node 2 over TNLA 2. The REBIND message indicates a UE list of 1 . . . 100. At 4, according to Action 302 and Action 303, Network node 2 may internally rebind the UEs of TNLA 1 to TNLA 2, UEs 1 to 100. That is, Network node 2 may update the UE TNLA bindings, so that TNLA 1 is left with no UEs and TNLA 2 is left with UEs 1 . . . 100, 101 . . . 200. At 5, according to Action 304 and Action 203, Network node 2 may send the REBIND ACKNOWLEDGE message to Network node 1 over TNLA 2. The second message may comprise the UE list including UE 1 to UE 100. At 6, TNLA 1 may be removed, following the specification of the application protocol. For this case, all the examples in described in relation to FIGS. 2 and 3, e.g., in the Sections under the heading “The Rebind Procedure” may be applied.

### Cloud Implementation

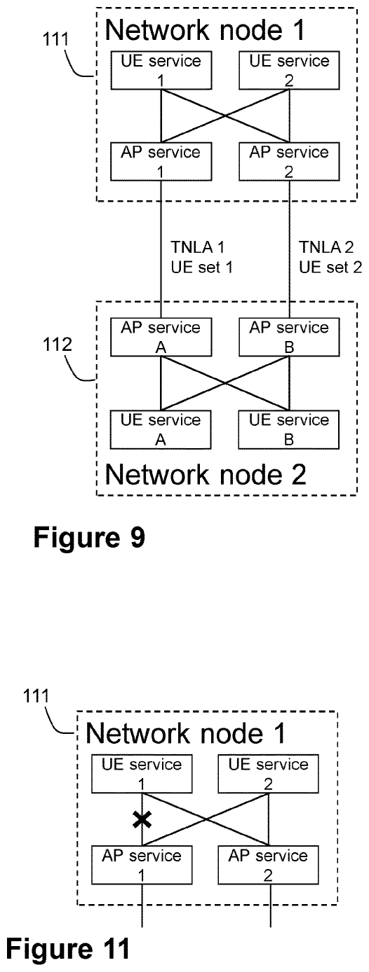

FIG. 9 is a schematic block diagram depicting a non-limiting example of a cloud architecture with multiple AP and UE service instances, according to embodiments herein. In a cloud implementation, it may be important to split the functionality into microservices. For a Cloud-Native Network Function (CNF) with a high availability requirement, the microservices may have to also be highly resilient to overcome the lower availability of the cloud infrastructure. A microservice may have to: a) be loosely coupled from other microservices, meaning that it may be independently upgraded and fail in isolation, b) able to run on different nodes; for increased availability, it may be important that instances of a service may be distributed across nodes, c) scale depending on load. An instance of a microservice may be added or deleted to cater for increased or decreased load respectively. FIG. 9 shows an example of such a cloud architecture for application protocols (APs) for which UE TNLA binding may apply. To shorten the description, the term service here may denote microservice. Each instance of a service may run on a separate node for robustness. The example architecture depicted in FIG. 9 comprises the first network node 111 as Network node 1 and the second network node 112 as Network node 1. The TNLAs for the network nodes may be terminated by separate AP service instances. The AP service instances may run on different physical nodes. Thus, a failure of one service instance or physical node may not bring down the interface service in general. The first network node 111 comprises two AP services, AP service 1 and AP service 2 and the second network node 112 comprises two AP services, AP service A and AP service B. The UE functionality may be handled by separate service instances, which may all connect to the AP service instances, full mesh. The first network node 111 comprises two UE services, UE service 1 and UE service 2, and the second network node 112 comprises two UE services, UE service A and UE service B. As the UE signaling is bound to a TNLA, the UE service may have to invoke the procedures towards the AP service instance handling that TNLA. Two TNLAs are established between the first network node 111 and the second network node 112. TNLA 1 is bound to UE set 1 and TNLA 2 is bound to UE set 2. If the UE service is stateful, meaning that one UE context belongs to one service instance, the F1AP service may need to signal to the UE service instance handling the UE in question.

### TNLA Failure

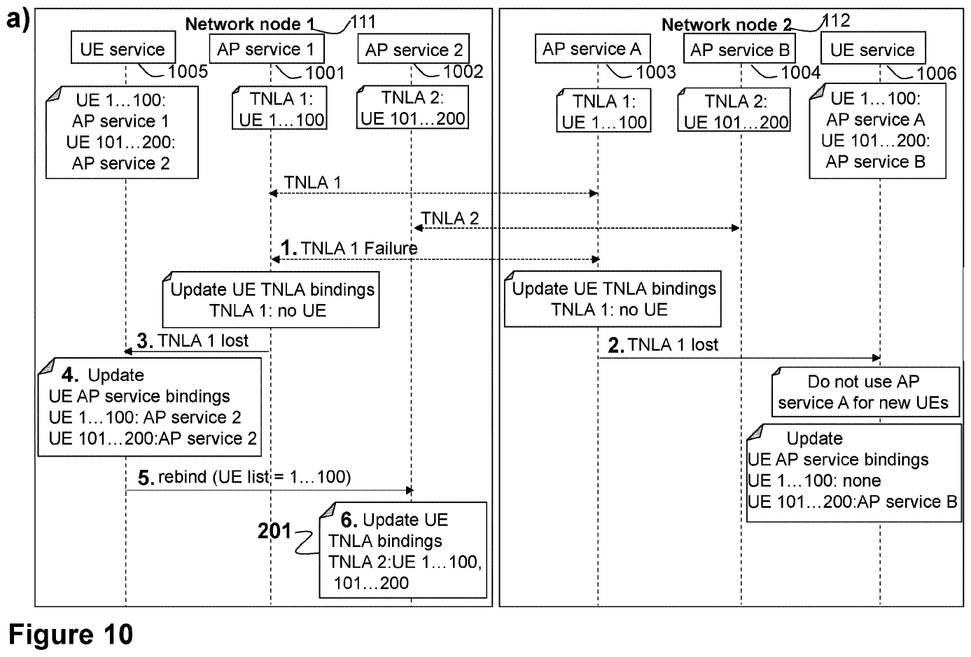

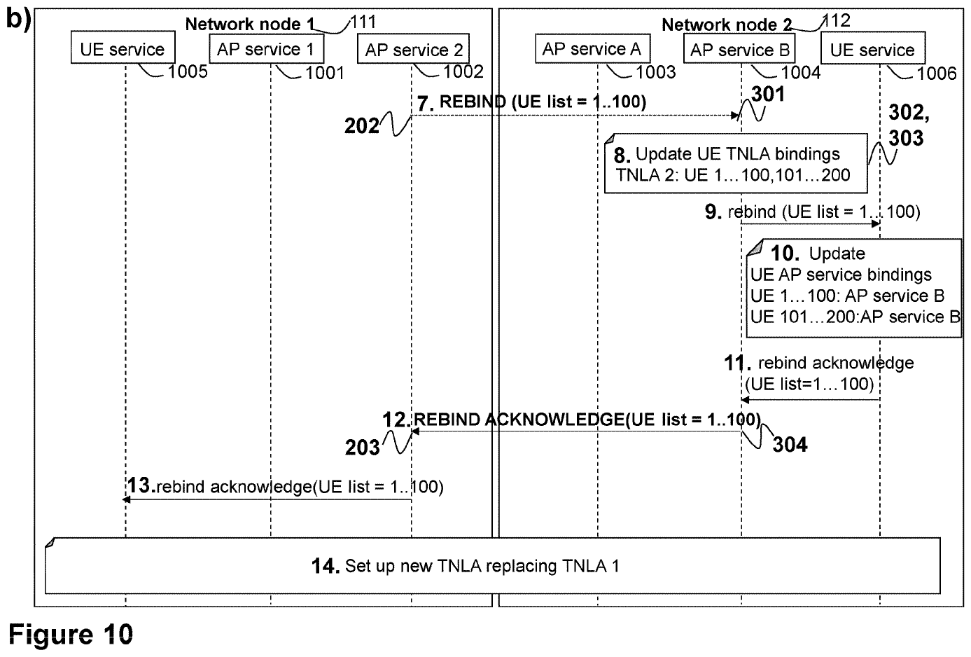

In a cloud environment, network issues may be expected to be more frequent. In case one of the TNLAs breaks due to network connectivity issues, the rebind procedure may be used to retain the one or more wireless devices 130, e.g., UEs, bound to that TNLA. FIG. 10 is a signalling diagram depicting a non-limiting example of a method performed in a communications network 100, according to embodiments herein. FIG. 10 particularly illustrates a sequence diagram of TNLA failure handling for an example cloud implementation. The first network node 111 comprises two AP services, AP service 1 1001 and AP service 2 1002 and the second network node 112 comprises two AP services, AP service A 1003 and AP service B 1004. The first network node 111 comprises one UE service 1005, and the second network node 112 comprises one UE service 1006. In the example shown in FIG. 10 there may be two TNLAs. In an initial state, TNLA 1 between AP service 1 and AP service A which has 100 UEs bound to it, and TNLA 2 between AP service 2 and AP service B which has 100 UEs. At 1, there is a failure on TNLA 1. Both network nodes may be notified by the transport network layer. Network node 2: At 2, AP service A 1003 may inform the UE service 1006 that the TNLA is lost. The UE service 1006 may stop using AP service A 1003. Network node 1: At 3, the AP service 1 1001 may inform the UE service 1005 that the TNLA is lost. At 4, UE service 1005 may rebind its UEs from AP service 1 1001 to AP service 2 1002. That is, UE service 1005 may update the AP service bindings, so that AP service 1 1001 is left with no UEs and AP service 2 1002 is left with UEs 1 . . . 100, 101 . . . 200. At 5, UE service 1005 may send an internal rebind message to AP service 2 1002. The internal rebind message may indicate a UE list of 1 . . . 100. At 6, according to Action 201, AP service 2 1002 may invoke the rebind procedure to bind the UEs to TNLA 2 through AP service 2 1002. That is, AP service 2 1002 may update the UE TNLA bindings, so that TNLA 1 is left with no UEs and TNLA 2 is left with UEs 1 . . . 100, 101 . . . 200. At 7, AP service 2 1002, in accordance with Action 202 and Action 301, may send a REBIND message to AP service B 1004 including a UE list of UE 1 . . . 100. Then, in Network node 2, at 8, according to Action 302 and Action 303, AP service B 1005 may update the bindings for the affected UEs to TNLA2. That is, AP service B 1004 may update the UE TNLA bindings, so that TNLA 1 is left with no UEs and TNLA 2 is left with UEs 1 . . . 100, 101 . . . 200. At 9, AP service B 1004 may send an internal rebind message to UE service 1006. The internal rebind message may indicate the UE list of 1 . . . 100. At 10, UE service 1006 may update the bindings for the affected UEs to AP service B, so that AP service A 1003 is left with no UEs and AP service B 1004 is left with UEs 1 . . . 100, 101 . . . 200. At 11, UE service 1006 may send an internal acknowledge message to AP service B 1004. The internal rebind acknowledge message may indicate a UE list of 1 . . . 100. At 12, according to Action 304 and Action 203, Network node 2 may acknowledge the rebinding to Network node 1 through AP service B 1004. Network node 1: At 13. AP service 2 1002 may forward the acknowledgement to UE service 1005. At 14, after, or in parallel with, the rebind procedure, a new TNLA replacing TNLA 1 may be set up according to the application protocol.

### Internal Network Node Error

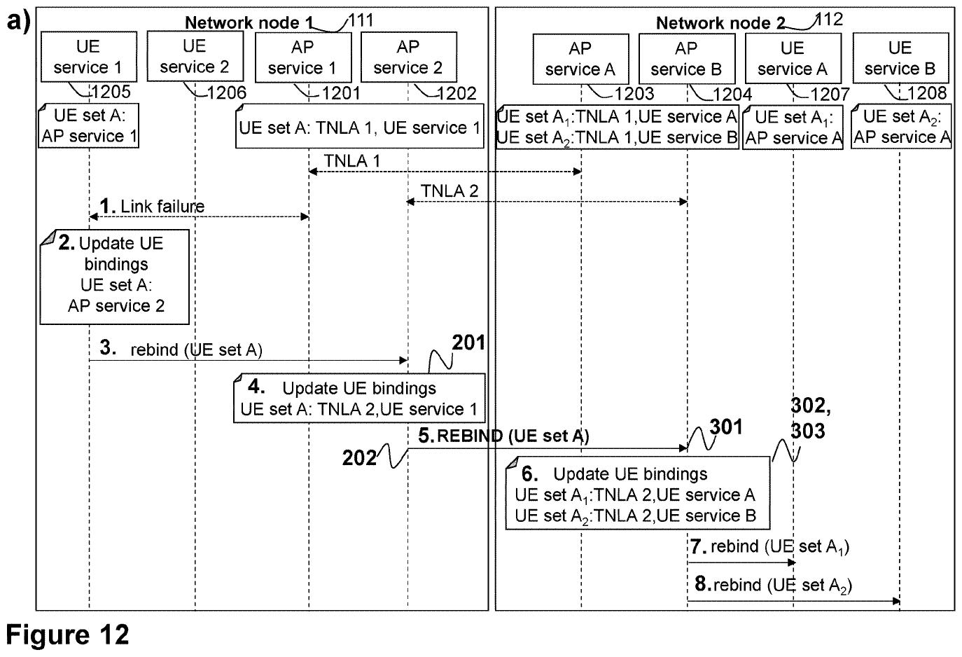

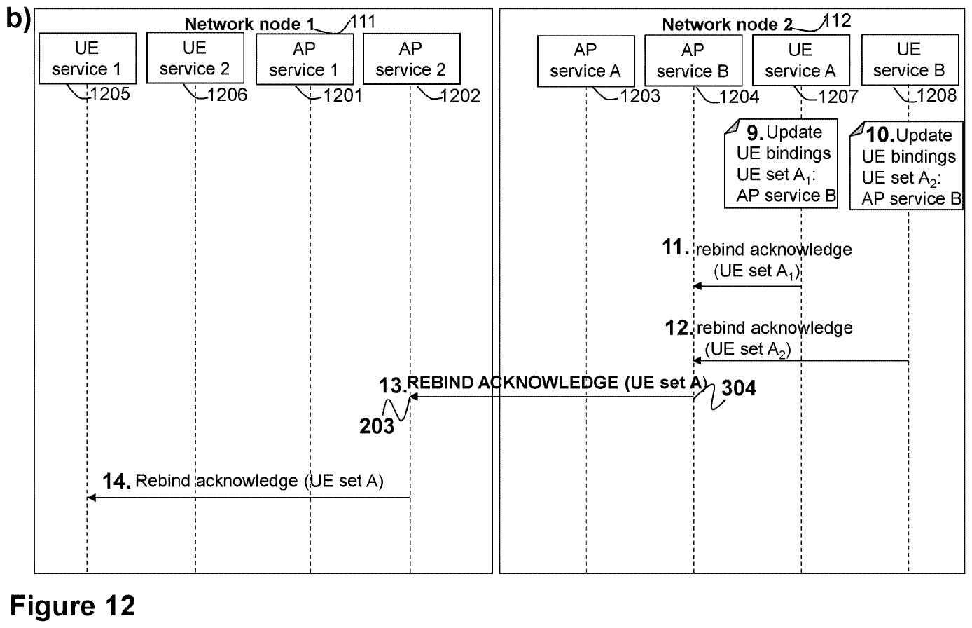

FIG. 11 is a signalling diagram depicting a non-limiting example of a method performed in a communications network 100, according to embodiments herein. FIG. 11 particularly illustrates a block diagram of an internal network issue within a network node, such as the network node 111. If a network node, such as the network node 111, encounters an internal error in the application handling a TNLA, it may rebind those UEs to another, working, path through the system. One example of this may be a network connectivity issue between a UE service and an AP service, as exemplified by UE service 1 and AP service 1 in FIG. 11. Here, UE service 1 may still provide service for its UEs through AP service 2. AP service 1 cannot determine if the lost connection to UE service 1 is due to a network issue or UE service 1 being out-of-service, so the rebinding may need to be initiated by UE service 1. The legacy alternative to this event may be for AP service 1 to reset all UEs affected by the issue. The sequence diagram of the example is shown in FIG. 12.

FIG. 12 is a signalling diagram depicting a non-limiting example of a method performed in a communications network 100, according to embodiments herein. FIG. 12 particularly illustrates a sequence diagram of internal network failure handling. The first network node 111 comprises two AP services, AP service 1 1201 and AP service 2 1202 and the second network node 112 comprises two AP services, AP service A 1203 and AP service B 1204. The first network node 111 comprises two UE services, UE service 1 1205 and UE service 2 1206, and the second network node 112 comprises two UE services, UE service A 1207 and UE service B 1208. In this example, only the UEs affected by the link failure between UE service 1 1205 and AP service 1 1201 are denoted. The set of UEs commonly handled by UE service 1 1205 and AP service 1 1201, denoted by UE set A, in Network node 1 are split up between the UE services in Network node 2, in subsets A1 and A2. This may be understood to be a probable case, as a network node's UE service may have no notion of the other network node's UE services. Network node 1: At 1, there may be an internal link failure between UE service 1 1205 and AP service 1 1201. At 2, UE service 1 1205 may rebind UE set A from AP service 1 1201 to AP service 2 1202. At 3, UE service 1 1205 may send an internal rebind message to AP service 2 1202. The internal rebind message may indicate the UE set A. At 4, according to Action 201, AP service 2 1202 may update bindings to TNLA 2 for UE set A. That is, AP service 2 1202 may update the UE TNLA bindings, so that TNLA 1 is left with no UEs and TNLA 2 is left with UE set A. It may be understood that, in reality, UE service 2 may still have a working connection to AP service 1 and have another set of UE still being bound to TNLA 1. For simplicity, this is not included in the example. At 5, AP service 2 1202 may invoke the rebind procedure to bind UE set A to TNLA 2. AP service 2 1202, in accordance with Action 202 and Action 301, may send a REBIND message to AP service B 1204 including an indication of UE set A. Then, in Network node 2: at 6, in accordance with Action 302 and Action 303, AP service B 1204 may update the bindings for the affected UEs to TNLA2. That is, AP service B 1204 may update the UE TNLA bindings, so that TNLA 1 is left with no UEs and TNLA 2 is left with UE subset A1 and UE subset A2. UE subset A1 is to be handled by UE service A 1207 and UE subset A2 is to be handled by UE service B 1208. At 7, AP service B 1204 may send an internal rebind message with UE set A1 to UE service A 1207. At 8, AP service B 1204 may send an internal rebind message with UE set A2 to UE service B 1208. At 9, UE service A 1207 may update the bindings for UE set A1 to AP service B 1204. At 10, UE service B 1208 may update the bindings for UE set A2 to AP service B 1204. At 11, UE service A 1207 may send an internal acknowledge message to AP service B 1204 indicating UE set A1. At 12. UE service B 1208 may send an internal acknowledge message to AP service B 1204 indicating UE set A2. At 13, in accordance with Action 304 and Action 301, AP service B 1204 may acknowledge the rebinding to Network node 1 by sending an internal rebind acknowledge message which may indicate the UE set A. Then, Network node 1, at 14, AP service 2 1202 may forward the acknowledgement to UE service 1 1205.

### In-Service Upgrade

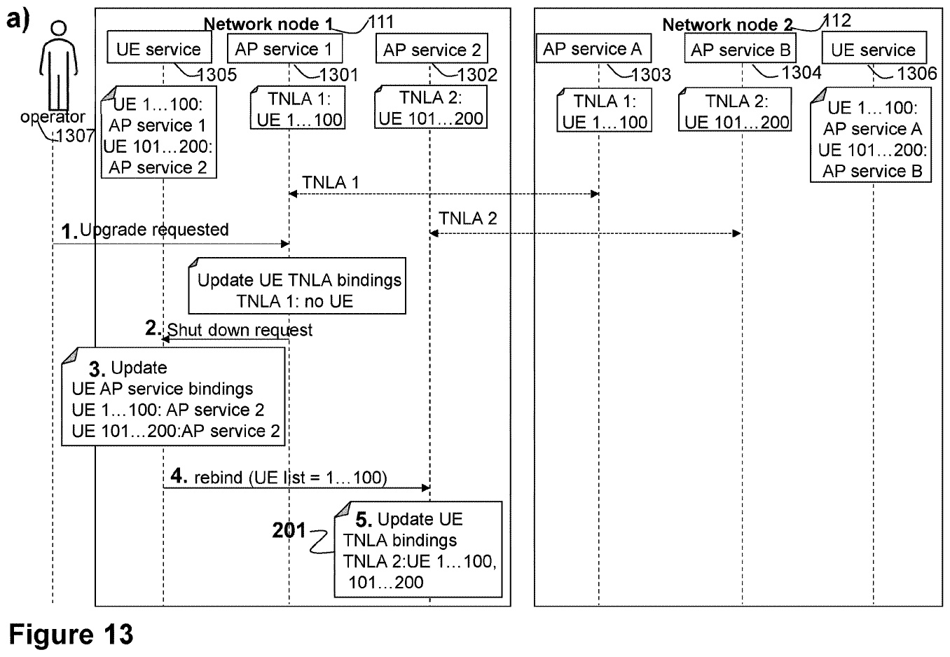

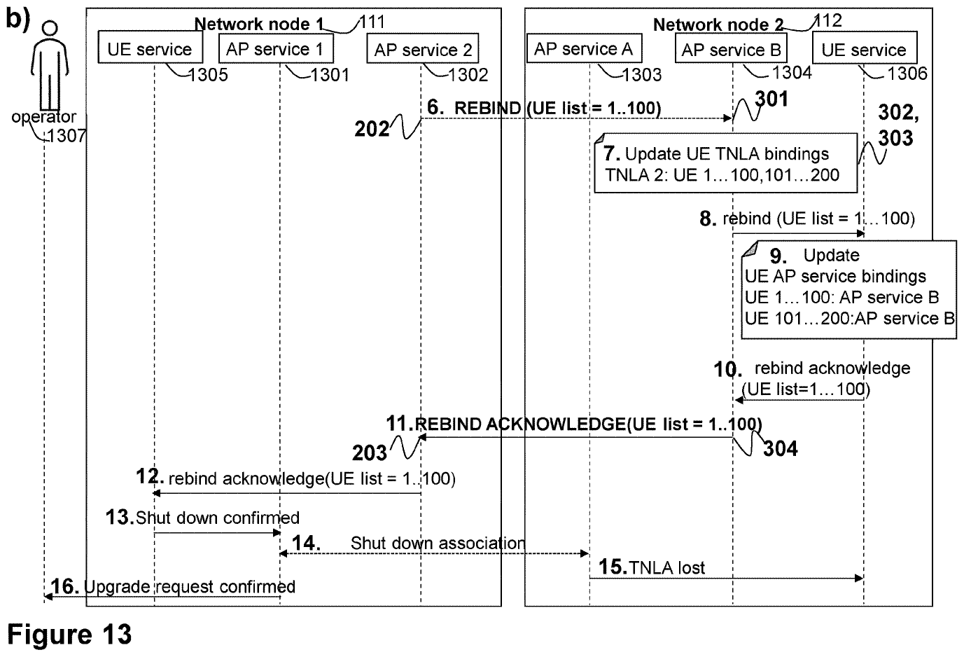

Another case is in-service upgrade. If the application instance servicing the endpoint needs to be upgraded without disturbing the service, the UEs may first be rebound to TNLAs on other endpoints. FIG. 13 shows an example with two network nodes. FIG. 13 is a signalling diagram depicting a non-limiting example of a method performed in a communications network 100, according to embodiments herein. FIG. 13 particularly illustrates a sequence diagram of in-service upgrade in an example cloud implementation. The first network node 111 comprises two AP services, AP service 1 1301 and AP service 2 1302 and the second network node 112 comprises two AP services, AP service A 1303 and AP service B 1304.

The first network node 111 comprises one UE service 1305, and the second network node 112 comprises one UE service 1306. FIG. 13 shows that the operator, or orchestrator, may request AP service 1 1301 of Network node 1 to be upgraded. After moving the UEs of its endpoint, AP service 1 1301 may close its TNLAs in accordance with the application protocol. Finally, the operator may be informed that upgrade may now be performed. The example is only showing one connected Network node, namely Network node 2. With more connected nodes, the procedure may need to be applied to all network nodes before AP service 1 1301 may be upgraded. In an initial state, there may be TNLA 1 between AP service 1 1301 and AP service A 1303, which has 100 UEs bound to it, and TNLA 2 between AP service 2 and AP service B which has 100 UEs. Network node 1: At 1, an operator 1307 may request an upgrade for AP service 1 1301. AP service 1 1301 may update TNLA bindings so that TNLA 1 is left with no UEs. At 2, AP service 1 1301 may signal to UE service 1305 that it may be going to be shut down. At 3, UE service 1305 may rebind the UEs of AP service 1 1301 to AP service 2 1302, so that AP service 1 1001 is left with no UEs and AP service 2 1302 is left with UEs 1 . . . 100, 101 . . . 200. At 4, UE service 1305 may send an internal rebind message to AP service 2 1302. The internal rebind message may indicate the UE list 1 . . . 100. At 5, in accordance with Action 201, AP service 2 1302 may update bindings to TNLA 2 for the given UEs. That is, AP service 2 1302 may update the UE TNLA bindings, so that TNLA 1 is left with no UEs and TNLA 2 is left with UEs 1 . . . 100, 101 . . . 200. At 6, in accordance with Action 202 and Action 301, AP service 2 1302 may invoke the rebind procedure towards Network node 2 over TNLA 2. AP service 2 1302, in accordance with Action 202 and Action 301, may send a REBIND message to AP service B 1304 including a UE list of UE 1 . . . 100. Then, in Network node 2: at 7, AP service B 1304, in accordance with Action 302 and Action 304, may update the bindings for the affected UEs to TNLA2. That is, AP service B 1304 may update the UE TNLA bindings, so that TNLA 1 is left with no UEs and TNLA 2 is left with UEs 1 . . . 100, 101 . . . 200. At 8, AP service B 1304 may send an internal rebind message to UE service 1306. The internal rebind message may indicate the UE list 1 . . . 100. At 9, UE service 1306 may update the bindings for the UEs to AP service B 1304, so that AP service A 1303 is left with no UEs and AP service B 1304 is left with UEs 1 . . . 100, 101 . . . 200. At 10, UE service 1306 may send an internal acknowledge message to AP service B 1304. At 11, AP service B 1304 may acknowledge the rebinding to Network node 1. AP service B 1304, in accordance with Action 304 and Action 203, may send a REBIND ACKNOWLEDGE message to AP service 2 1302 including a UE list of UE 1 . . . 100. Then, in Network node 2, at 12, AP service 2 1302 may forward the acknowledgement to UE service 1305. At 13, UE service 1305 may confirm that AP service 1 1301 may be shut down. At 14, AP service 1 1301 may close TNLA 1. At 15, AP service A 1303 may send an internal message to UE service 1306 indicating that TNLA 1 is lost. UE service 1306 may then be aware not to use AP service A 1303 for new UEs. At 16, AP service 1 1301 may confirm to the operator/orchestrator 1307 that it may be upgraded.

As a summarized overview of the foregoing, embodiments herein may be understood to introduce an explicit procedure for updating the TNLA bindings of the one or more wireless devices 130, e.g., the UE TNLA bindings, and for the establishment of prioritization between nodes involved in the TNLA binding, in case of conflicting rebinding indications.

Certain embodiments disclosed herein may provide one or more of the following technical advantage(s), which may be summarized as follows.

By introducing a UE TNLA rebind procedure to be used for e.g., the F1AP, E1AP, NGAP and XNAP interfaces, a set of the one or more wireless devices 130, e.g., UEs, may instantly be bound to another TNLA. This may be understood to enable keeping the sessions of the one or more wireless devices 130, e.g., UE sessions, during, e.g.: failures on interface level, internal errors, and termination of TNLAs. It may also enable load-balancing of the one or more wireless devices 130, e.g., UEs, and minimize the risk of conflicting rebind decisions between the communicating network nodes.

These are the advantages of the proposed approach as compared to existing technology. One advantage may be understood to be that in case of a failure, the UE TNLA binding may immediately be synchronized between the first network node 111, e.g., a CU, and the second network node 112, e.g., a DU.

Another advantage may be understood to be that in a cloud implementation with separate microservices for interface handling and UE handling, internal communication errors may be mitigated by rebinding the UEs to a working path through the system.

Yet another advantage may be understood to be that if a TNLA is to be removed, the UEs bound to it may be retained and it may be explicitly specified to which TNLA the UEs may need to be rebound. For a cloud implementation, this graceful TNLA removal may be applied when the microservice instance terminating the TNLA may need to be upgraded.

A further advantage may be understood to be that with a rebind procedure the semantics may be clearer, rather than having the TNLA UE rebinding as a side-effect of another UE associated procedure.

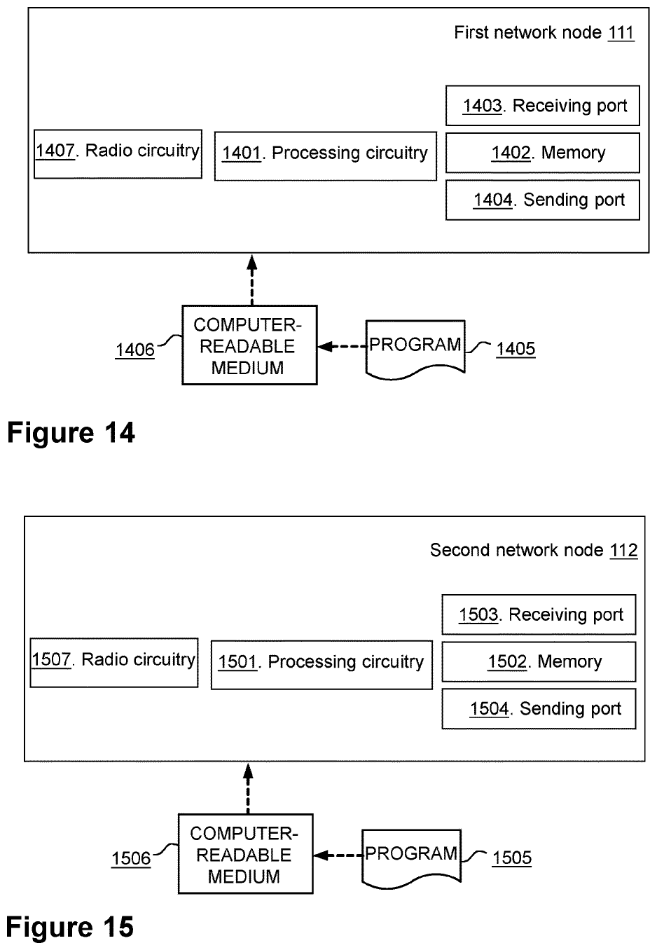

FIG. 14 depicts an example of the arrangement that the first network node 111 may comprise to perform the method actions described above in relation to FIG. 2, and/or any of FIGS. 4-13. The first network node 111 is configured to operate in the communications network 100. The first network node 111 may be understood to be for handling the one or more connections.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111 and will thus not be repeated here. For example, in some embodiments, the communications network 100 may be a Cloud RAN network.

The first network node 111 is configured and/or operable to perform the determining in Action 201, e.g. by means of a processing circuitry 1401 within the first network node 111, configured to determine that the re-binding between the one or more signalling connections from the one or more wireless devices 130 and the TNLA is to be performed.

The first network node 111 is also configured and/or operable to perform the sending in Action 202, e.g. by means of the processing circuitry 1401 within the first network node 111, configured to send, to the second network node 112 configured to operate in the communications network 100. The first message is configured to indicate that the re-binding is to be performed. The first message is configured to further indicate how the re-binding is to be performed. The first message is configured to be the dedicated message, and one of the following applies: a) the first message is configured to indicate to which TNLA the one or more wireless devices 130 are to be rebound, and b) the first message is configured to be sent over the TNLA to which the one or more wireless devices 130 are to be rebound.

In some embodiments, one of the following may apply: a) the first message may be configured to indicate the list of the one or more identifiers configured to identify the one or more wireless devices 130 that may have to be rebound, and to which TNLA the one or more wireless devices 130 may have to be rebound, b) the first message may be configured to indicate the list of the one or more identifiers, and the first message may be configured to be sent over the TNLA to which the one or more wireless devices 130 may have to be rebound, and c) the first message may be configured to be associated to a respective wireless device of the one or more wireless devices 130.

The first network node 111 may be configured and/or operable to perform the receiving in Action 203, e.g. by means of the processing circuitry 1401 within the first network node 111, configured to receive, from the second network node 112, the second message. The second message may be configured to indicate whether or not the re-binding was successful.

In some embodiments, the second message may be configured to indicate one of the following: a) successful re-binding of the one or more wireless devices 130, b) successful re-binding of the first subset of the one or more wireless devices 130 and failed re-binding of the second subset of the one or more wireless devices 130, c) successful re-binding of the first subset of the one or more wireless devices 130, failed re-binding of the second subset of the one or more wireless devices 130, and the indication that the further re-binding procedure for the second set may have to be initiated, d) successful re-binding of the first subset of the one or more wireless devices 130, failed re-binding of the second subset of the one or more wireless devices 130, the indication that the further re-binding procedure for the second set is to be initiated, and the further indication configured to indicate the cause of the failed re-binding, e) failed re-binding of the one or more wireless devices 130, f) failed re-binding of the one or more wireless devices 130, and the further indication configured to indicate the cause of the failed re-binding, and g) failed re-binding of the one or more of the one or more wireless devices 130, and the additional indication configured to indicate the back-off timer, the back-off timer being configured to indicate the time before which the first network node 111 is not to initiate a new re-binding procedure.

The first network node 111 may be configured and/or operable to perform the obtaining in Action 200, e.g. by means of the processing circuitry 1401 within the first network node 111, configured to obtain the first indication configured to indicate the respective precedence of the plurality of first messages received from the plurality of network nodes 110, wherein the first messages in the plurality may be in conflict with each other, and the determining may be configured to be based on the first indication configured to be obtained.

The embodiments herein in the first network node 111 may be implemented through one or more processors, such as a processing circuitry 1401 in the first network node 111 depicted in FIG. 14, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The processing circuitry 1401 may be configured to, or operable to, perform the method actions according to FIG. 2, and/or any of FIGS. 4-13.

The first network node 111 may further comprise a memory 1402 comprising one or more memory units. The memory 1402 is arranged to be used to store obtained information, store data, configurations, schedulings, and applications etc. to perform the methods herein when being executed in the first network node 111.

In some embodiments, the first network node 111 may receive information from, e.g., the second network node 112, the third network node 113, another or a different network node, any of the one or more wireless devices 130 operating in the communications network 100, and/or another structure in the communications network 100, through a receiving port 1403. In some embodiments, the receiving port 1403 may be, for example, connected to one or more antennas in first network node 111. In other embodiments, the first network node 111 may receive information from another structure in the communications network 100 through the receiving port 1403. Since the receiving port 1403 may be in communication with the processing circuitry 1401, the receiving port 1403 may then send the received information to the processing circuitry 1401. The receiving port 1403 may also be configured to receive other information.

The processing circuitry 1401 in the first network node 111 may be further configured to transmit or send information to e.g., the second network node 112 the third network node 113, another or a different network node, any of the one or more wireless devices 130 operating in the communications network 100, and/or another structure in the communications network 100, through a sending port 1404, which may be in communication with the processing circuitry 1401, and the memory 1402.

Those skilled in the art will also appreciate that the processing circuitry 1401 described above may comprise a combination of analog and digital modules, and/or one or more processors configured with software and/or firmware, e.g., stored in memory, that, when executed by the one or more processors such as the processing circuitry 1401, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the first network node 111 may be configured to perform the actions of FIG. 2, and/or any of FIGS. 4-13 with respective units that may be implemented as one or more applications running on one or more processors such as the processing circuitry 1401.

Thus, the methods according to the embodiments described herein for the first network node 111 may be respectively implemented by means of a computer program 1405 product, comprising instructions, i.e., software code portions, which, when executed on at least one processing circuitry 1401, cause the at least one processing circuitry 1401 to carry out the actions described herein, as performed by the first network node 111. The computer program 1405 product may be stored on a computer-readable storage medium 1406. The computer-readable storage medium 1406, having stored thereon the computer program 1405, may comprise instructions which, when executed on at least one processing circuitry 1401, cause the at least one processing circuitry 1401 to carry out the actions described herein, as performed by the first network node 111. In some embodiments, the computer-readable storage medium 1406 may be a non-transitory computer-readable storage medium, such as a CD ROM disc, or a memory stick. In other embodiments, the computer program 1405 product may be stored on a carrier containing the computer program 1405 just described, wherein the carrier is one of an electronic signal, optical signal, radio signal, or the computer-readable storage medium 1406, as described above.

The first network node 111 may comprise a communication interface configured to facilitate communications between the first network node 111 and other nodes or devices, e.g., the second network node 112, the third network node 113, another or a different network node, any of the one or more wireless devices 130 operating in the communications network 100, and/or another structure in the communications network 100. The interface may, for example, include a transceiver configured to transmit and receive radio signals over an air interface in accordance with a suitable standard.

In other embodiments, the first network node 111 may also comprise a radio circuitry 1407, which may comprise e.g., the receiving port 1403 and the sending port 1404. The radio circuitry 1407 may be configured to set up and maintain at least a wireless connection with the second network node 112, the one or more third network nodes 113, the one or more fourth network nodes 114, one or more devices, e.g., the one or more wireless devices 130, operating in the communications network 100, and/or another structure in the communications network 100. Circuitry may be understood herein as a hardware component.

Hence, embodiments herein also relate to the first network node 111 comprising the processing circuitry 1401 and the memory 1402, said memory 1402 containing instructions executable by said processing circuitry 1401, whereby the first network node 111 is operative to perform the actions described herein in relation to the first network node 111, e.g., in FIG. 2, and/or any of FIGS. 4-13.

FIG. 15 depicts an example of the arrangement that the second network node 112 may comprise to perform the method actions described above in relation to FIG. 3, and/or any of FIGS. 4-13. The second network node 112 is configured to operate in the communications network 100. The second network node 112 may be understood to be for handling the one or more connections.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second network node 112 and will thus not be repeated here. For example, in some embodiments, the communications network 100 may be a Cloud RAN network.

The second network node 112 is configured and/or operable to perform the receiving in Action 301, e.g. by means of a processing circuitry 1501 within the second network node 112, configured to receive, from the first network node 111 configured to operate in the communications network 100, the first message configured to indicate that the re-binding between the one or more signalling connections from the one or more wireless devices 130 and the TNLA is to be performed. The first message is configured to further indicate how the re-binding is to be performed. The first message is configured to be a dedicated message, and one of: a) the first message is configured to indicate to which TNLA the one or more wireless devices 130 are to be rebound, and b) the first message is configured to be received over the TNLA to which the one or more wireless devices 130 are to be rebound.

In some embodiments, one of the following may apply: a) the first message may be configured to indicate the list of the one or more identifiers configured to identify the one or more wireless devices 130 that may have to be rebound, and to which TNLA the one or more wireless devices 130 may have to be rebound, b) the first message may be configured to indicate the list of the one or more identifiers, and the first message may be configured to be sent over the TNLA to which the one or more wireless devices 130 may have to be rebound, and c) the first message may be configured to be associated to a respective wireless device of the one or more wireless devices 130.

In some embodiments, the second network node 112 may be further configured with the following three configurations.

The second network node 112 may be configured and/or operable to perform the determining in Action 302, e.g. by means of the processing circuitry 1501 within the second network node 112, configured to determine, based on the first message configured to be received, that the re-binding between the one or more signalling connections from the one or more wireless devices 130 and the TNLA may have to be performed.

The second network node 112 may be configured and/or operable to perform the initiating in Action 303, e.g. by means of the processing circuitry 1501 within the second network node 112, configured to initiate the re-binding between the one or more signalling connections from the one or more wireless devices 130 and the TNLA.

The second network node 112 may be configured and/or operable to perform the sending in Action 304, e.g. by means of the processing circuitry 1501 within the second network node 112, configured to send, to the first network node 111, the second message. The second message may be configured to indicate whether or not the re-binding was successful.

In some embodiments, the second message may be configured to indicate one of the following: a) successful re-binding of the one or more wireless devices 130, b) successful re-binding of the first subset of the one or more wireless devices 130 and failed re-binding of the second subset of the one or more wireless devices 130, c) successful re-binding of the first subset of the one or more wireless devices 130, failed re-binding of the second subset of the one or more wireless devices 130, and the indication that the further re-binding procedure for the second set may have to be initiated, d) successful re-binding of the first subset of the one or more wireless devices 130, failed re-binding of the second subset of the one or more wireless devices 130, the indication that the further re-binding procedure for the second set is to be initiated, and the further indication configured to indicate the cause of the failed re-binding, e) failed re-binding of the one or more wireless devices 130, f) failed re-binding of the one or more wireless devices 130, and the further indication configured to indicate the cause of the failed re-binding, and g) failed re-binding of the one or more of the one or more wireless devices 130, and the additional indication configured to indicate the back-off timer, the back-off timer being configured to indicate the time before which the first network node 111 is not to initiate a new re-binding procedure.

The second network node 112 may be configured and/or operable to perform the obtaining in Action 300, e.g. by means of the processing circuitry 1501 within the second network node 112, configured to obtain the first indication configured to indicate the § respective precedence of the plurality of first messages configured to be received from the plurality of network nodes 110, wherein the first messages in the plurality may be in conflict with each other, and the determining may be configured to be based on the first indication configured to be obtained.

The embodiments herein in the second network node 112 may be implemented through one or more processors, such as a processing circuitry 1501 in the second network node 112 depicted in FIG. 15, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The processing circuitry 1501 may be configured to, or operable to, perform the method actions according to FIG. 3, and/or any of FIGS. 4-13.

The second network node 112 may further comprise a memory 1502 comprising one or more memory units. The memory 1502 is arranged to be used to store obtained information, store data, configurations, schedulings, and applications etc. to perform the methods herein when being executed in the second network node 112.

In some embodiments, the second network node 112 may receive information from, e.g., the first network node 111, the third network node 113, another or a different network node, any of the one or more wireless devices 130 operating in the communications network 100, and/or another structure in the communications network 100, through a receiving port 1503. In some embodiments, the receiving port 1503 may be, for example, connected to one or more antennas in second network node 112. In other embodiments, the second network node 112 may receive information from another structure in the communications network 100 through the receiving port 1503. Since the receiving port 1503 may be in communication with the processing circuitry 1501, the receiving port 1503 may then send the received information to the processing circuitry 1501. The receiving port 1503 may also be configured to receive other information.

The processing circuitry 1501 in the second network node 112 may be further configured to transmit or send information to e.g., the first network node 111, the third network node 113, another or a different network node, any of the one or more wireless devices 130 operating in the communications network 100, and/or another structure in the communications network 100, through a sending port 1504, which may be in communication with the processing circuitry 1501, and the memory 1502.

Those skilled in the art will also appreciate that the processing circuitry 1501 described above may comprise a combination of analog and digital modules, and/or one or more processors configured with software and/or firmware, e.g., stored in memory, that, when executed by the one or more processors such as the processing circuitry 1501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the second network node 112 may be configured to perform the actions of FIG. 3, and/or any of FIGS. 4-13 with respective units that may be implemented as one or more applications running on one or more processors such as the processing circuitry 1501.

Thus, the methods according to the embodiments described herein for the second network node 112 may be respectively implemented by means of a computer program 1505 product, comprising instructions, i.e., software code portions, which, when executed on at least one processing circuitry 1501, cause the at least one processing circuitry 1501 to carry out the actions described herein, as performed by the second network node 112. The computer program 1505 product may be stored on a computer-readable storage medium 1506. The computer-readable storage medium 1506, having stored thereon the computer program 1505, may comprise instructions which, when executed on at least one processing circuitry 1501, cause the at least one processing circuitry 1501 to carry out the actions described herein, as performed by the second network node 112. In some embodiments, the computer-readable storage medium 1506 may be a non-transitory computer-readable storage medium, such as a CD ROM disc, or a memory stick. In other embodiments, the computer program 1505 product may be stored on a carrier containing the computer program 1505 just described, wherein the carrier is one of an electronic signal, optical signal, radio signal, or the computer-readable storage medium 1506, as described above.

The second network node 112 may comprise a communication interface configured to facilitate communications between the second network node 112 and other nodes or devices, e.g., the first network node 111, the third network node 113, another or a different network node, any of the one or more wireless devices 130 operating in the communications network 100, and/or another structure in the communications network 100. The interface may, for example, include a transceiver configured to transmit and receive radio signals over an air interface in accordance with a suitable standard.

In other embodiments, the second network node 112 may also comprise a radio circuitry 1507, which may comprise e.g., the receiving port 1503 and the sending port 1504. The radio circuitry 1507 may be configured to set up and maintain at least a wireless connection with the first network node 111, the third network node 113, another or a different network node, any of the one or more wireless devices 130 operating in the communications network 100, and/or another structure in the communications network 100. Circuitry may be understood herein as a hardware component.

Hence, embodiments herein also relate to the second network node 112 comprising the processing circuitry 1501 and the memory 1502, said memory 1502 containing instructions executable by said processing circuitry 1501, whereby the second network node 112 is operative to perform the actions described herein in relation to the second network node 112, e.g., in FIG. 3, and/or any of FIGS. 4-13.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

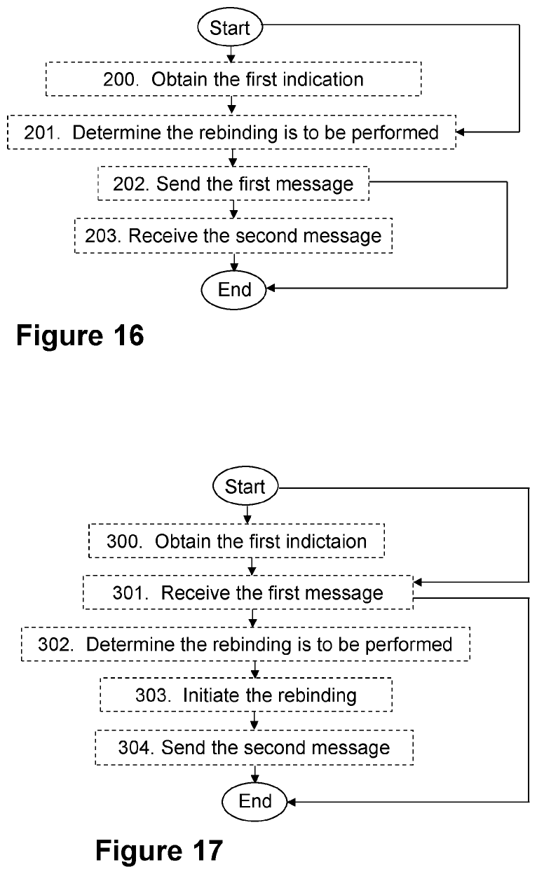

The following are examples related to embodiments herein. Any of the features described in relation to FIGS. 1-15 may be combined with the actions of the examples related to embodiments herein, described in relation to FIGS. 16-17.

The first network node 111 embodiments relate to FIG. 16, FIGS. 4-13, FIG. 14, and FIGS. 18-23.

A method, performed by a first network node, such as the first network node 111 is described herein. The method may be understood to be for handling one or more connections, e.g., one or more signalling connections. The first network node 111 may be operating in a communications network, such as the communications network 100.

In some embodiments, the communications network 100 may be a Cloud RAN network.

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first network node 111 is depicted in FIG. 16. In FIG. 16, optional actions in some embodiments may be represented with dashed lines. In some embodiments, the actions may be performed in a different order than that depicted FIG. 16.
Determining 201 that a re-binding may have to be performed. The first network node 111 may be configured and/or operable to perform the determining in this Action 201.

Determining may be understood as calculating, deriving, or similar.

The re-binding may be between one or more connections, or one or more first connections, e.g., one or more signalling connections, from one or more wireless devices 130 and a Transport Network Layer Association, TNLA. That is, the first network node 111 may determine that a re-binding between the one or more signalling connections from the one or more wireless devices 130 and the Transport Network Layer Association, TNLA, may have to be performed, e.g., from a first TNLA to a second TNLA.

In some embodiments, the determining 201 may be based on, e.g., triggered by or subsequent to, at least one of: a) a failure of the first TNLA; in some of such embodiments the rebinding may be to a working TNLA, b) after an internal error, e.g., at the first network node 111, for example, a temporary internal error, e.g., a failure of a service instance or a physical node, c) an overload situation, e.g., therefore, as part of a load balancing procedure, d) a TNLA shutdown, e.g., a shutdown of the first TNLA, e) an XN setup request, f) a network connectivity issue, and g) a service upgrade.
Sending 202 a first message. The first network node 111 may be configured and/or operable to perform the sending in this Action 202.

The sending in this Action 202 may be to the second network node 112 operating in the communications network 100, e.g., via the first link 141.

The first message may indicate that the re-binding may have to be performed. The first message may further indicate how the re-binding may have to be performed.

In some embodiments, one of the following options may apply:
the first message may indicate a list of one or more identifiers; the one or more identifiers may identify the one or more wireless devices 130 that may have to be rebound, and to which TNLA the one or more wireless devices 130 may have to be rebound, e.g., the second TNLA the one or more wireless devices 130 may have to be rebound to,
the first message may indicate the list of the one or more identifiers; the first message may be sent over the TNLA to which the one or more wireless devices 130 may have to be rebound, e.g., may be sent over the second TNLA, and
the first message may be a dedicated message, e.g., associated to a respective wireless device of the one or more wireless devices 130, and one of: a) the first message may indicate to which TNLA the one or more wireless devices 130 may have to be rebound, e.g., the second TNLA the one or more wireless devices 130 may have to be rebound to, and b) the first message may be sent over the TNLA to which the one or more wireless devices 130 may have to be rebound, e.g., may be sent over the second TNLA.

The first message may be a first rebind message, e.g., a rebind request.

In some examples, the first message may be, e.g., an internal rebind message.
Receiving 203 a second message. The first network node 111 may be configured and/or operable to perform the receiving in this Action 203.

The receiving in this Action 203 may be from the second network node 112, e.g., via the first link 141.

The second message may indicate whether or not the re-binding was successful.

The second message may indicate one of the following:
successful re-binding of the one or more wireless devices 130,
successful re-binding of a first subset of the one or more wireless devices 130 and failed re-binding of a second subset of the one or more wireless devices 130,
successful re-binding of the first subset of the one or more wireless devices 130, failed re-binding of the second subset of the one or more wireless devices 130, and an indication that a further re-binding procedure for the second set may have to be initiated,
successful re-binding of the first subset of the one or more wireless devices 130, failed re-binding of the second subset of the one or more wireless devices 130, the indication that a further re-binding procedure for the second set may have to be initiated, and a further indication indicating a cause of the failed re-binding,
failed re-binding of the one or more wireless devices 130,
failed re-binding of the one or more wireless devices 130, and the further indication indicating the cause of the failed re-binding, and
failed re-binding of one or more of the one or more wireless devices 130, and an additional indication indicating a back-off timer; the back-off timer may indicate a time before which the first network node 111 may have to not initiate a new re-binding procedure.

In second message may be a second rebind message, e.g., a rebind response, such as a rebind failure message, a rebind acknowledge message.
Obtaining 200 a first indication. The first network node 111 may be configured and/or operable to perform the obtaining in this Action 200.

The obtaining in this Action 200 may be performed by receiving from the second network node 112, e.g., via the first link 141, or from another network node, e.g., a core network node operating in the communications network 100, or by retrieving from a memory, e.g., within the first network node 111.

The first indication may indicate a respective precedence, or respective priority, of a plurality of first messages received from a plurality of network nodes 110. The first messages in the plurality may be in conflict with each other. In other words, the first indication may indicate a network node 111, 113 of the plurality of network nodes 110 that may have to take precedence in case of conflict between the plurality of first messages received from the plurality of network nodes 110. Expressed differently, the first indication may indicate a respective priority of a respective network node, of a plurality of network nodes 110, wherein the respective priority may be understood to be for a respective precedence of a respective first message of the respective network node of the plurality of network nodes, over respective first messages from other network nodes in the plurality of network nodes 110, e.g., which first messages may be in conflict of each other.

The determining in Action 202 may be based on the obtained first indication.

The first indication may be a configuration, e.g., a pre-configuration.

The first indication may be a rebinding priority indication.

In FIG. 16, optional units are indicated with dashed boxes.

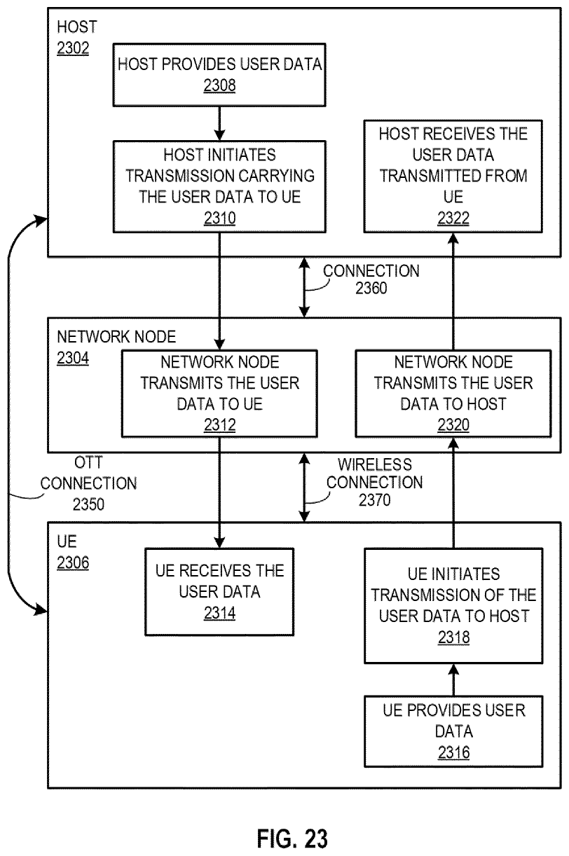

The first network node 111 may comprise an arrangement as shown in FIG. 14 or in FIG. 23.

The second network node 112 embodiments relate to FIG. 17, FIGS. 4-13, FIG. 15, and FIGS. 18-23.

A method, performed by a second network node, such as the second network node 112 is described herein. The method may be understood to be for handling the one or more connections, e.g., the one or more signalling connections. The second network node 112 may be operating in a communications network, such as the communications network 100.

In some embodiments, the communications network 100 may be a Cloud RAN network. The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second network node 112 is depicted in FIG. 17. In FIG. 17, optional actions in some embodiments may be represented with dashed lines. In some embodiments, the actions may be performed in a different order than that depicted FIG. 17.
Receiving 301 the first message. The second network node 112 may be configured and/or operable to perform the receiving in this Action 301.

The receiving in this Action 301 may be from the first network node 111 operating in the communications network 100.

The first message may indicate that the re-binding may have to be performed.

The re-binding may be between the one or more connections, or the one or more first connections, e.g., the one or more signalling connections, from the one or more wireless devices 130 and the TNLA. That is, the first network node 111 may determine that the re-binding between the one or more signalling connections from the one or more wireless devices 130 and the TNLA may have to be performed, e.g., from the first TNLA to the second TNLA.

The first message may further indicate how the re-binding may have to be performed.

The receiving in this Action 301 may be performed, e.g., via the first link 141.

In some embodiments, one of the following options may apply:
the first message may indicate the list of the one or more identifiers; the one or more identifiers may identify the one or more wireless devices 130 that may have to be rebound; the first message may further indicate to which TNLA the one or more wireless devices 130 may have to be rebound, e.g., the second TNLA the one or more wireless devices 130 may have to be rebound to,
the first message may indicate the list of the one or more identifiers; the first message may be received over the TNLA to which the one or more wireless devices 130 may have to be rebound, e.g., may be received over the second TNLA, and
the first message may be the dedicated message, e.g., associated to a respective wireless device of the one or more wireless devices 130, and one of: a) the first message may indicate to which TNLA the one or more wireless devices 130 may have to be rebound, e.g., the second TNLA the one or more wireless devices 130 may have to be rebound to, and b) the first message may be received over the TNLA to which the one or more wireless devices 130 may have to be rebound, e.g., may be received over the second TNLA.
Determining 302 that the re-binding between the one or more connections, e.g., the one or more signalling connections, from the one or more wireless devices 130 and the TNLA, e.g., the second TNLA, may have to be performed. The second network node 112 may be configured and/or operable to perform the determining in this Action 302.
Initiating 303 the re-binding. The second network node 112 may be configured and/or operable to perform the initiating in this Action 303.

The initiating in this Action 303 may be understood as starting, triggering, or enabling. The re-binding may be between the one or more signalling connections from the one or more wireless devices 130 and the TNLA, e.g., the second TNLA.
Sending 304 the second message. The second network node 112 may be configured and/or operable to perform the sending in this Action 304.

The sending in this Action 304 may be to the first network node 111.

The second message may indicate whether or not the re-binding was successful.

The second message may indicate one of the following:
successful re-binding of the one or more wireless devices 130,
successful re-binding of the first subset of the one or more wireless devices 130 and failed re-binding of the second subset of the one or more wireless devices 130,
successful re-binding of the first subset of the one or more wireless devices 130, failed re-binding of the second subset of the one or more wireless devices 130, and the indication that the further re-binding procedure for the second set may have to be initiated,
successful re-binding of the first subset of the one or more wireless devices 130, failed re-binding of the second subset of the one or more wireless devices 130, the indication that the further re-binding procedure for the second set may have to be initiated, and the further indication indicating the cause of the failed re-binding,
failed re-binding of the one or more wireless devices 130,
failed re-binding of the one or more wireless devices 130, and the further indication indicating the cause of the failed re-binding, and
failed re-binding of the one or more of the one or more wireless devices 130, and the additional indication indicating the back-off timer; the back-off timer may indicate the time before which the first network node 111 may have to not initiate the new re-binding procedure.
Obtaining 300 the first indication. The second network node 112 may be configured and/or operable to perform the obtaining in this Action 300.

The obtaining in this Action 300 may be performed by receiving from the first network node 111, e.g., via the first link 141, or from another network node, e.g., a core network node operating in the communications network 100, or by retrieving from a memory, e.g., within the second network node 112.

The first indication may indicate the respective precedence, or respective priority, of the plurality of first messages received from the plurality of network nodes 110. The first messages in the plurality may be in conflict with each other. In other words, the first indication may indicate the network node 111, 113 of the plurality of network nodes 110 that may have to take precedence in case of conflict between the plurality of first messages received from the plurality of network nodes 110. Expressed differently, the first indication may indicate the respective priority of the respective network node, of the plurality of network nodes 110, wherein the respective priority may be understood to be for the respective precedence of the respective first message of the respective network node of the plurality of network nodes, over the respective first messages from other network nodes in the plurality of network nodes 110, e.g., which first messages may be in conflict of each other.

The determining in Action 302 may be based on the obtained first indication.

In FIG. 17, optional units are indicated with dashed boxes.

The second network node 112 may comprise an arrangement as shown in FIG. 15 or in FIG. 23.

### Selected Examples Related to Examples Herein

EXAMPLE 1. A method performed by a first network node (111), the method being for handling one or more connections, the first network node (111) operating in a communications network (100), and the method comprising:
   determining (201) that a re-binding between one or more signalling connections from one or more wireless devices (130) and a Transport Network Layer Association, TNLA, is to be performed, e.g., from a first TNLA to a second TNLA, and
   sending (202), to a second network node (112) operating in the communications network (100), a first message indicating that the re-binding is to be performed, and wherein the first message further indicates how the re-binding is to be performed.
EXAMPLE 2. The method according to example 1, wherein one of:
   the first message indicates a list of one or more identifiers identifying the one or more wireless devices (130) that are to be rebound, and to which TNLA the one or more wireless devices (130) are to be rebound, e.g., the second TNLA the one or more wireless devices (130) are to be rebound to,
   the first message indicates the list of the one or more identifiers, and wherein the first message is sent over the TNLA to which the one or more wireless devices (130) are to be rebound, e.g., is sent over the second TNLA, and
   the first message is a dedicated message, e.g., associated to a respective wireless device of the one or more wireless devices (130), and wherein one of: a) the first message indicates to which TNLA the one or more wireless devices (130) are to be rebound, e.g., the second TNLA the one or more wireless devices (130) are to be rebound to, and b) the first message is sent over the TNLA to which the one or more wireless devices (130) are to be rebound, e.g., is sent over the second TNLA.
EXAMPLE 3. The method according to any of examples 1-2, further comprising:
   receiving (203), from the second network node (112), a second message, the second message indicating whether or not the re-binding was successful.
EXAMPLE 4. The method according to example 3, wherein the second message indicates one of:
   successful re-binding of the one or more wireless devices (130),
   successful re-binding of a first subset of the one or more wireless devices (130) and failed re-binding of a second subset of the one or more wireless devices (130),
   successful re-binding of the first subset of the one or more wireless devices (130), failed re-binding of the second subset of the one or more wireless devices (130), and an indication that a further re-binding procedure for the second set is to be initiated,
   successful re-binding of the first subset of the one or more wireless devices (130), failed re-binding of the second subset of the one or more wireless devices (130), the indication that a further re-binding procedure for the second set is to be initiated, and a further indication indicating a cause of the failed re-binding, and
   failed re-binding of the one or more wireless devices (130), and
   failed re-binding of the one or more wireless devices (130), and the further indication indicating the cause of the failed re-binding,
   failed re-binding of one or more of the one or more wireless devices (130), and an additional indication indicating a back-off timer, the back-off timer indicating a time before which the first network node (111) is not to initiate a new re-binding procedure.
EXAMPLE 5. The method according to any of examples 1-4, further comprising:
   obtaining (200) a first indication indicating a respective precedence of a plurality of first messages received from a plurality of network nodes (110), wherein the first messages in the plurality are in conflict with each other, and wherein the determining (202) is based on the obtained first indication, in other words, the first indication indicates a network node (111, 113) of the plurality of network nodes (110) that is to take precedence in case of conflict between the plurality of first messages received from the plurality of network nodes (110).
EXAMPLE 6. The method according to any of examples 1-4, further comprising:
   obtaining (200) a first indication indicating a respective precedence of a plurality of first messages received from a plurality of network nodes (110), wherein the first messages in the plurality are in conflict with each other, and wherein the determining (202) is based on the obtained first indication, in other words, the first indication indicates a network node (111, 113) of the plurality of network nodes (110) that is to take precedence in case of conflict between the plurality of first messages received from the plurality of network nodes (110).
EXAMPLE 7. A method performed by a second network node (112), the method being for handling one or more connections, the second network node (112) operating in a communications network (100), and the method comprising:
   receiving (301), from a first network node (111) operating in the communications network (100), a first message indicating that a re-binding between one or more signalling connections from one or more wireless devices (130) and a Transport Network Layer Association, TNLA, is to be performed, e.g., from a first TNLA to a second TNLA, and wherein the first message further indicates how the re-binding is to be performed.
EXAMPLE 8. The method according to example 6, wherein one of:
   the first message indicates a list of one or more identifiers identifying the one or more wireless devices (130) that are to be rebound, and to which TNLA the one or more wireless devices (130) are to be rebound, e.g., the second TNLA the one or more wireless devices (130) are to be rebound to,
   the first message indicates the list of the one or more identifiers, and wherein the first message is received over the TNLA to which the one or more wireless devices (130) are to be rebound, e.g., is received over the second TNLA, and
   the first message is a dedicated message, e.g., associated to a respective wireless device of the one or more wireless devices (130), and wherein one of: a) the first message indicates to which TNLA the one or more wireless devices (130) are to be rebound, e.g., the second TNLA the one or more wireless devices (130) are to be rebound to, and b) the first message is received over the TNLA to which the one or more wireless devices (130) are to be rebound, e.g., is received over the second TNLA.
EXAMPLE 9. The method according to any of examples 6-7, further comprising:
   determining (302), based on the received first message, that the re-binding between the one or more signalling connections from the one or more wireless devices (130) and the TNLA, e.g., the second TNLA, is to be performed,
   initiating (303) the re-binding between the one or more signalling connections from the one or more wireless devices (130) and the TNLA, e.g., the second TNLA, and
   sending (304), to the first network node (111), a second message, the second message indicating whether or not the re-binding was successful.
EXAMPLE 10. The method according to example 8, wherein the second message indicates one of:
   successful re-binding of the one or more wireless devices (130), successful re-binding of a first subset of the one or more wireless devices (130) and failed re-binding of a second subset of the one or more wireless devices (130),
   successful re-binding of the first subset of the one or more wireless devices (130), failed re-binding of the second subset of the one or more wireless devices (130), and an indication that a further re-binding procedure for the second set is to be initiated,
   successful re-binding of the first subset of the one or more wireless devices (130), failed re-binding of the second subset of the one or more wireless devices (130), the indication that a further re-binding procedure for the second set is to be initiated, and a further indication indicating a cause of the failed re-binding, and
   failed re-binding of the one or more wireless devices (130), and
   failed re-binding of the one or more wireless devices (130), and the further indication indicating the cause of the failed re-binding,
   failed re-binding of one or more of the one or more wireless devices (130), and an additional indication indicating a back-off timer, the back-off timer indicating a time before which the first network node (111) is not to initiate a new re-binding procedure.
EXAMPLE 11. The method according to any of examples 8-9, further comprising:
   obtaining (300) a first indication indicating a respective precedence of a plurality of first messages received from a plurality of network nodes (110), wherein the first messages in the plurality are in conflict with each other, and wherein the determining (302) is based on the obtained first indication, in other words, the first indication indicates a network node (111, 113) of the plurality of network nodes (110) that is to take precedence in case of conflict between the plurality of first messages received from the plurality of network nodes (110).

### Further Extensions and Variations

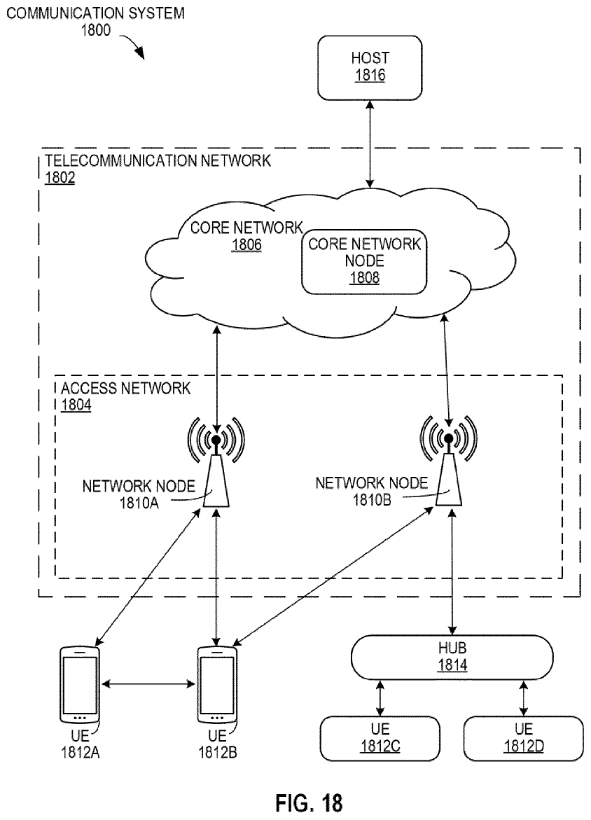

FIG. 18 shows an example of a communication system 1800 in accordance with some embodiments.

In the example, the communication system 1800, such as the communications network 100, includes a telecommunication network 1802 that includes an access network 1804, such as a radio access network (RAN), and a core network 1806, which includes one or more core network nodes 1808. The access network 1804 includes one or more access network nodes, such as any of the first network node 111 and the second network node 112. For example, network nodes 1810a and 1810b (one or more of which may be generally referred to as network nodes 1810), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1802 includes one or more Open-RAN (ORAN) network nodes. An ORAN network node is a node in the telecommunication network 1802 that supports an ORAN specification (e.g., a specification published by the O-RAN Alliance, or any similar organization) and may operate alone or together with other nodes to implement one or more functionalities of any node in the telecommunication network 1802, including one or more network nodes 1810 and/or core network nodes 1808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1810 facilitate direct or indirect connection of user equipment (UE), such as by connecting UEs 1812a, 1812b, 1812c, and 1812d (one or more of which may be generally referred to as UEs 1812) to the core network 1806 over one or more wireless connections. Any of the UEs 1812a, 1812b, 1812c, and 1812d are examples of the one or more wireless devices.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The one or more wireless device 130, exemplified in FIG. 18 as the UEs 1812 may be any of a wide variety of communication devices, including wireless devices arranged, configured, and/or operable to communicate wirelessly with any of the first network node 111 and the second network node 112, exemplified in FIG. 18 as network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1802 is a cellular network that implements 3GPP standardized features. Accordingly, the telecommunications network 1802 may support network slicing to provide different logical networks to different devices that are connected to the telecommunication network 1802. For example, the telecommunications network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1814 communicates with the access network 1804 to facilitate indirect communication between one or more UEs (e.g., UE 1812c and/or 1812d) and network nodes (e.g., network node 1810b). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a VR headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular if one or more of the UEs are low energy IoT devices.

The hub 1814 may have a constant/persistent or intermittent connection to the network node 1810b. The hub 1814 may also allow for a different communication scheme and/or schedule between the hub 1814 and UEs (e.g., UE 1812c and/or 1812d), and between the hub 1814 and the core network 1806. In other examples, the hub 1814 is connected to the core network 1806 and/or one or more UEs via a wired connection. Moreover, the hub 1814 may be configured to connect to an M2M service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810b. In other embodiments, the hub 1814 may be a non-dedicated hub—that is, a device which is capable of operating to route communications between the UEs and network node 1810b, but which is additionally capable of operating as a communication start and/or end point for certain data channels.

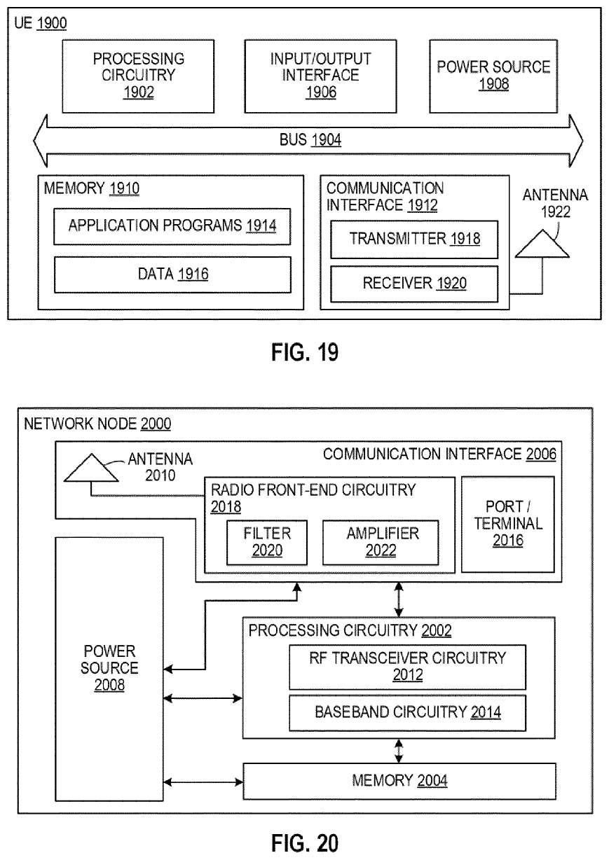

FIG. 19 shows a UE 1900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1902 may include multiple central processing units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging of the power source 1908. Power circuitry may perform any formatting, converting, or other modification to the power from the power source 1908 to make the power suitable for the respective components of the UE 1900 to which power is supplied.

The memory 1910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1910 may allow the UE 1900 to access instructions, application programs and the like, stored on transitory or non-transitory memory media, to off-load data, or to upload data. An article of manufacture, such as one utilizing a communication system may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., antenna 1922) and may share circuit components, software or firmware, or alternatively be implemented separately.

In the illustrated embodiment, communication functions of the communication interface 1912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node 2000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes a processing circuitry 2002, a memory 2004, a communication interface 2006, and a power source 2008. The network node 2000 may be composed of multiple physically separate components (e.g., a NodeB component and a RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, to provide network node 2000 functionality.

In some embodiments, the processing circuitry 2002 includes a system on a chip (SOC). In some embodiments, the processing circuitry 2002 includes one or more of radio frequency (RF) transceiver circuitry 2012 and baseband processing circuitry 2014. In some embodiments, the radio frequency (RF) transceiver circuitry 2012 and the baseband processing circuitry 2014 may be on separate chips (or sets of chips), boards, or units, such as radio units and digital units. In alternative embodiments, part or all of RF transceiver circuitry 2012 and baseband processing circuitry 2014 may be on the same chip or set of chips, boards, or units.

The memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. Radio front-end circuitry 2018 comprises filters 2020 and amplifiers 2022. The radio front-end circuitry 2018 may be connected to an antenna 2010 and processing circuitry 2002. The radio front-end circuitry may be configured to condition signals communicated between antenna 2010 and processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of filters 2020 and/or amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface may comprise different components and/or different combinations of components.

In certain alternative embodiments, the network node 2000 does not include separate radio front-end circuitry 2018, instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes one or more ports or terminals 2016, the radio front-end circuitry 2018, and the RF transceiver circuitry 2012, as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, communication interface 2006, and/or the processing circuitry 2002 may be configured to perform any receiving operations and/or certain obtaining operations described herein as being performed by the network node. Any information, data and/or signals may be received from a UE, another network node and/or any other network equipment. Similarly, the antenna 2010, the communication interface 2006, and/or the processing circuitry 2002 may be configured to perform any transmitting operations described herein as being performed by the network node. Any information, data and/or signals may be transmitted to a UE, another network node and/or any other network equipment.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

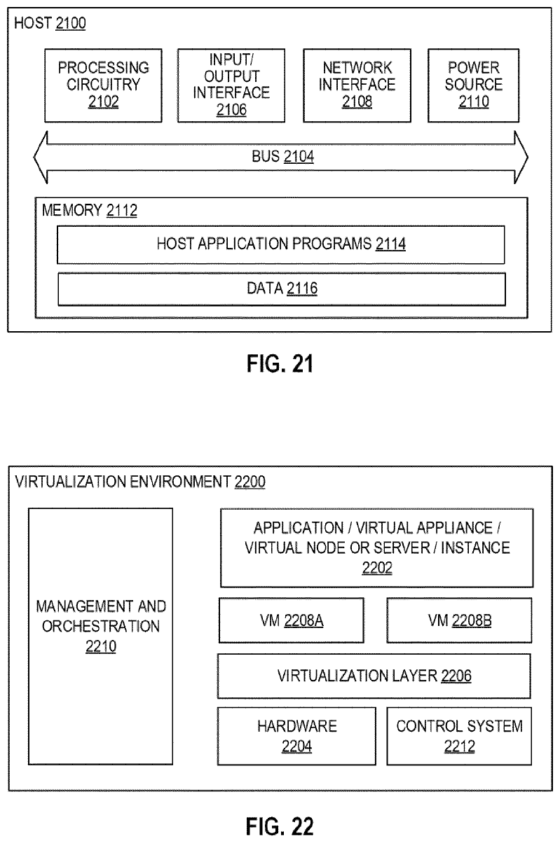

FIG. 21 is a block diagram of a host 2100, which may be an embodiment of the host 1816 of FIG. 18, in accordance with various aspects described herein. As used herein, the host 2100 may be or comprise various combinations hardware and/or software, including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and a memory 2112. Other components may be included in other embodiments. Features of these components may be substantially similar to those described with respect to the devices of previous figures, such as FIGS. 19 and 20, such that the descriptions thereof are generally applicable to the corresponding components of host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for over-the-top services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2200 includes components defined by the O-RAN Alliance, such as an O-Cloud environment orchestrated by a Service Management and Orchestration Framework via an O-2 interface.

Applications 2202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or virtual machine monitors (VMMs)), provide VMs 2208a and 2208b (one or more of which may be generally referred to as VMs 2208), and/or perform any of the functions, features and/or benefits described in relation with some embodiments described herein. The virtualization layer 2206 may present a virtual operating platform that appears like networking hardware to the VMs 2208.

The VMs 2208 comprise virtual processing, virtual memory, virtual networking or interface and virtual storage, and may be run by a corresponding virtualization layer 2206. Different embodiments of the instance of a virtual appliance 2202 may be implemented on one or more of VMs 2208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2208 may be a software implementation of a physical machine that runs programs as if they were executing on a physical, non-virtualized machine. Each of the VMs 2208, and that part of hardware 2204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2208 on top of the hardware 2204 and corresponds to the application 2202.

Hardware 2204 may be implemented in a standalone network node with generic or specific components. Hardware 2204 may implement some functions via virtualization. Alternatively, hardware 2204 may be part of a larger cluster of hardware (e.g. such as in a data center or CPE) where many hardware nodes work together and are managed via management and orchestration 2210, which, among others, oversees lifecycle management of applications 2202. In some embodiments, hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2212 which may alternatively be used for communication between hardware nodes and radio units.

FIG. 23 shows a communication diagram of a host 2302 communicating via a network node 2304 with a UE 2306 over a partially wireless connection in accordance with some embodiments. Example implementations, in accordance with various embodiments, of the UE (such as a UE 1812a of FIG. 18 and/or UE 1900 of FIG. 19), network node (such as network node 1810a of FIG. 18 and/or network node 2000 of FIG. 20), and host (such as host 1816 of FIG. 18 and/or host 2100 of FIG. 21) discussed in the preceding paragraphs will now be described with reference to FIG. 23.

Like host 2100, embodiments of host 2302 include hardware, such as a communication interface, processing circuitry, and memory. The host 2302 also includes software, which is stored in or accessible by the host 2302 and executable by the processing circuitry. The software includes a host application that may be operable to provide a service to a remote user, such as the UE 2306 connecting via an over-the-top (OTT) connection 2350 extending between the UE 2306 and host 2302. In providing the service to the remote user, a host application may provide user data which is transmitted using the OTT connection 2350.

The network node 2304 includes hardware enabling it to communicate with the host 2302 and UE 2306. The connection 2360 may be direct or pass through a core network (like core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by UE 2306 and executable by the UE's processing circuitry. The software includes a client application, such as a web browser or operator-specific “app” that may be operable to provide a service to a human or non-human user via UE 2306 with the support of the host 2302. In the host 2302, an executing host application may communicate with the executing client application via the OTT connection 2350 terminating at the UE 2306 and host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via a connection 2360 between the host 2302 and the network node 2304 and via a wireless connection 2370 between the network node 2304 and the UE 2306 to provide the connection between the host 2302 and the UE 2306. The connection 2360 and wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304, in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

One or more of the various embodiments improve the performance of OTT services provided to the UE 2306 using the OTT connection 2350, in which the wireless connection 2370 forms the last segment. More precisely, the teachings of these embodiments may improve data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR or AR which it can broadcast, multicast or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2350 between the host 2302 and UE 2306, in response to variations in the measurement results. The measurement procedure and/or the network functionality for reconfiguring the OTT connection may be implemented in software and hardware of the host 2302 and/or UE 2306. In some embodiments, sensors (not shown) may be deployed in or in association with other devices through which the OTT connection 2350 passes; the sensors may participate in the measurement procedure by supplying values of the monitored quantities exemplified above, or supplying values of other physical quantities from which software may compute or estimate the monitored quantities. The reconfiguring of the OTT connection 2350 may include message format, retransmission settings, preferred routing etc.; the reconfiguring need not directly alter the operation of the network node 2304. Such procedures and functionalities may be known and practiced in the art. In certain embodiments, measurements may involve proprietary UE signaling that facilitates measurements of throughput, propagation times, latency and the like, by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The first network node 111 embodiments relate to FIG. 2, FIGS. 4-13, FIG. 14, and FIGS. 18-23.

The first network node 111 may comprise an arrangement as shown in FIG. 14 or in FIG. 23.

The second network node 112 embodiments relate to FIG. 3, FIGS. 4-13, FIG. 15, and FIGS. 18-23.

The second network node 112 may comprise an arrangement as shown in FIG. 15 or in FIG. 23.

### Further Numbered Embodiments

1. A host configured to operate in a communication system to provide a service, e.g., an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by any of the first network node 111 and the second network node 112.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by any of the first network node 111 and the second network node 112.

4. The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by any of the first network node 111 and the second network node 112.

7. The communication system of the previous embodiment, further comprising:
the network node; and/or
the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by any of the first network node 111 and the second network node 112.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by any of the first network node 111 and the second network node 112.

13. The method of the previous embodiment, further comprising at the network node, transmitting the received user data to the host.

### REFERENCES

1. “5G; NG-RAN; Architecture Description”, 3GPP TS 38.401, rel. 17, chapters 8.8, 8.10, 11.1 https://www.etsi.org/deliver/etsi_ts/138400_138499/138401/17.03.00_60/ts_138401v170 300p.pdf
2. “5G; NG-RAN; F1 signalling transport”, 3GPP TS 38.472, rel. 17, chapter 7 https://www.etsi.org/deliver/etsi_ts/138400_138499/138472/17.01.00_60/ts_138472v170 100p.pdf
3. “Method for Selecting the Transport Network Layer Association (TNLA) within 5G RAN Systems”, US Patent Application Publication No. 2022/0030512 A1, Srinivasan Sundararajan, 2022 Jan. 27.

1. A method performed by a first network node, the method being for handling one or more connections, the first network node operating in a communications network, the method comprising:
determining that a re-binding between one or more signalling connections from one or more wireless devices and a Transport Network Layer Association, TNLA, is to be performed; and
sending, to a second network node operating in the communications network, a first message indicating that the re-binding is to be performed, the first message further indicating how the re-binding is to be performed, the first message being a dedicated message, and one of: a) the first message indicating to which TNLA the one or more wireless devices are to be rebound, and b) the first message being sent over the TNLA to which the one or more wireless devices are to be rebound.

2. The method according to claim 1, wherein one of:
the first message indicates a list of one or more identifiers identifying the one or more wireless devices that are to be rebound, and to which TNLA the one or more wireless devices are to be rebound;
the first message indicates the list of the one or more identifiers, and wherein the first message is sent over the TNLA to which the one or more wireless devices are to be rebound; and
the first message is associated to a respective wireless device of the one or more wireless devices.

3. The method according to claim 1, further comprising:
receiving, from the second network node, a second message, the second message indicating whether or not the re-binding was successful.

4. The method according to claim 3, wherein the second message indicates one of:
successful re-binding of the one or more wireless devices;
successful re-binding of a first subset of the one or more wireless devices and failed re-binding of a second subset of the one or more wireless devices;
successful re-binding of the first subset of the one or more wireless devices, failed re-binding of the second subset of the one or more wireless devices, and an indication that a further re-binding procedure for the second set is to be initiated;
successful re-binding of the first subset of the one or more wireless devices, failed re-binding of the second subset of the one or more wireless devices, the indication that a further re-binding procedure for the second set is to be initiated, and a further indication indicating a cause of the failed re-binding;
failed re-binding of the one or more wireless devices;
failed re-binding of the one or more wireless devices, and the further indication indicating the cause of the failed re-binding; and
failed re-binding of one or more of the one or more wireless devices, and an additional indication indicating a back-off timer, the back-off timer indicating a time before which the first network node is not to initiate a new re-binding procedure.

5. The method according to claim 1, further comprising:
obtaining a first indication indicating a respective precedence of a plurality of first messages received from a plurality of network nodes, wherein the first messages in the plurality are in conflict with each other, and wherein the determining is based on the obtained first indication.

6. A method performed by a second network node, the method being for handling one or more connections, the second network node operating in a communications network, the method comprising:
receiving, from a first network node operating in the communications network, a first message indicating that a re-binding between one or more signalling connections from one or more wireless devices and a Transport Network Layer Association, TNLA, is to be performed, the first message further indicating how the re-binding is to be performed, the first message being a dedicated message, and one of: a) the first message indicating to which TNLA the one or more wireless devices are to be rebound, and b) the first message being received over the TNLA to which the one or more wireless devices are to be rebound.

7. The method according to claim 6, wherein one of:
the first message indicates a list of one or more identifiers identifying the one or more wireless devices that are to be rebound, and to which TNLA the one or more wireless devices are to be rebound;
the first message indicates the list of the one or more identifiers, and wherein the first message is received over the TNLA to which the one or more wireless devices are to be rebound; and
the first message is associated to a respective wireless device of the one or more wireless devices.

8. The method according to claim 6, further comprising:
determining, based on the received first message, that the re-binding between the one or more signalling connections from the one or more wireless devices and the TNLA is to be performed;
initiating the re-binding between the one or more signalling connections from the one or more wireless devices and the TNLA; and
sending, to the first network node, a second message, the second message indicating whether or not the re-binding was successful.

9. The method according to claim 8, wherein the second message indicates one of:
successful re-binding of the one or more wireless devices;
successful re-binding of a first subset of the one or more wireless devices and failed re-binding of a second subset of the one or more wireless devices;
successful re-binding of the first subset of the one or more wireless devices, failed re-binding of the second subset of the one or more wireless devices, and an indication that a further re-binding procedure for the second set is to be initiated;
successful re-binding of the first subset of the one or more wireless devices, failed re-binding of the second subset of the one or more wireless devices, the indication that a further re-binding procedure for the second set is to be initiated, and a further indication indicating a cause of the failed re-binding;
failed re-binding of the one or more wireless devices;
failed re-binding of the one or more wireless devices, and the further indication indicating the cause of the failed re-binding; and
failed re-binding of one or more of the one or more wireless devices, and an additional indication indicating a back-off timer, the back-off timer indicating a time before which the first network node is not to initiate a new re-binding procedure.

10. The method according to claim 8, further comprising:
obtaining a first indication indicating a respective precedence of a plurality of first messages received from a plurality of network nodes, wherein the first messages in the plurality are in conflict with each other, and wherein the determining is based on the obtained first indication.

11. A first network node, for handling one or more connections, the first network node being configured to operate in a communications network, and the first network node being further configured to:
determine that a re-binding between one or more signalling connections from one or more wireless devices and a Transport Network Layer Association, TNLA, is to be performed; and
send, to a second network node configured to operate in the communications network, a first message configured to indicate that the re-binding is to be performed, the first message indicating how the re-binding is to be performed, the first message being a dedicated message, and one of: a) the first message indicating to which TNLA the one or more wireless devices are to be rebound, and b) the first message being sent over the TNLA to which the one or more wireless devices are to be rebound.

12. The first network node according to claim 11, wherein one of:
the first message is configured to indicate a list of one or more identifiers configured to identify the one or more wireless devices that are to be rebound, and to which TNLA the one or more wireless devices are to be rebound;
the first message is configured to indicate the list of the one or more identifiers, and wherein the first message is configured to be sent over the TNLA to which the one or more wireless devices are to be rebound; and
the first message is configured to be associated to a respective wireless device of the one or more wireless devices.

13. The first network node according to claim 11, being further configured to:
receive, from the second network node, a second message, the second message being configured to indicate whether or not the re-binding was successful.

14. The first network node according to claim 13, wherein the second message is configured to indicate one of:
successful re-binding of the one or more wireless devices;
successful re-binding of a first subset of the one or more wireless devices and failed re-binding of a second subset of the one or more wireless devices;
successful re-binding of the first subset of the one or more wireless devices, failed re-binding of the second subset of the one or more wireless devices, and an indication that a further re-binding procedure for the second set is to be initiated;
successful re-binding of the first subset of the one or more wireless devices, failed re-binding of the second subset of the one or more wireless devices, the indication that a further re-binding procedure for the second set is to be initiated, and a further indication configured to indicate a cause of the failed re-binding;
failed re-binding of the one or more wireless devices;
failed re-binding of the one or more wireless devices, and the further indication configured to indicate the cause of the failed re-binding; and
failed re-binding of one or more of the one or more wireless devices, and an additional indication configured to indicate a back-off timer, the back-off timer being configured to indicate a time before which the first network node is not to initiate a new re-binding procedure.

15. The first network node claim 11, being further configured to:
obtain a first indication configured to indicate a respective precedence of a plurality of first messages received from a plurality of network nodes, wherein the first messages in the plurality are in conflict with each other, and wherein the determining is configured to be based on the first indication configured to be obtained.

16. A second network node, for handling one or more connections, the second network node being configured to operate in a communications network, and the second network node being further configured to:
receive, from a first network node configured to operate in the communications network, a first message configured to indicate that a re-binding between one or more signalling connections from one or more wireless devices and a Transport Network Layer Association, TNLA, is to be performed, the first message indicating how the re-binding is to be performed, the first message being a dedicated message, and one of: a) the first message indicating to which TNLA the one or more wireless devices are to be rebound, and b) the first message being received over the TNLA to which the one or more wireless devices are to be rebound.

17. The second network node according to claim 16, wherein one of:
the first message is configured to indicate a list of one or more identifiers configured to identify the one or more wireless devices that are to be rebound, and to which TNLA the one or more wireless devices are to be rebound;
the first message is configured to indicate the list of the one or more identifiers, and wherein the first message is configured to be received over the TNLA to which the one or more wireless devices are to be rebound; and
the first message is configured to be associated to a respective wireless device of the one or more wireless devices.

18. The second network node according to claim 16, being further configured to:
determine, based on the first message configured to be received, that the re-binding between the one or more signalling connections from the one or more wireless devices and the TNLA is to be performed;
initiate the re-binding between the one or more signalling connections from the one or more wireless devices and the TNLA; and
send, to the first network node, a second message, the second message being configured to indicate whether or not the re-binding was successful.

19. The second network node according to claim 18, wherein the second message is configured to indicate one of:
successful re-binding of the one or more wireless devices;
successful re-binding of a first subset of the one or more wireless devices and failed re-binding of a second subset of the one or more wireless devices;
successful re-binding of the first subset of the one or more wireless devices, failed re-binding of the second subset of the one or more wireless devices, and an indication that a further re-binding procedure for the second set is to be initiated;
successful re-binding of the first subset of the one or more wireless devices, failed re-binding of the second subset of the one or more wireless devices, the indication that a further re-binding procedure for the second set is to be initiated, and a further indication configured to indicate a cause of the failed re-binding;
failed re-binding of the one or more wireless devices;
failed re-binding of the one or more wireless devices, and the further indication configured to indicate the cause of the failed re-binding; and
failed re-binding of one or more of the one or more wireless devices, and an additional indication configured to indicate a back-off timer, the back-off timer being configured to indicate a time before which the first network node is not to initiate a new re-binding procedure.

20. The second network node according to claim 18, being further configured to:
obtain a first indication configured to indicate a respective precedence of a plurality of first messages configured to be received from a plurality of network nodes, wherein the first messages in the plurality are in conflict with each other, and wherein the determining is configured to be based on the first indication configured to be obtained.
